(19) United States
(12) Patent Application Publication
(10) Pub. No.: US 2026/0039985 A1
(43) Pub. Date: Feb. 5, 2026

(54) SOUND APPARATUS AND TRANSPORTATION APPARATUS COMPRISING THE SAME

(71) Applicant: LG Display Co., Ltd., Seoul (KR)

(72) Inventors: Min Kyu Choi, Gyeonggi-do (KR); Do Hyeong Kim, Gyeonggi-do (KR)

(21) Appl. No.: 19/096,620

(22) Filed: Mar. 31, 2025

(30) Foreign Application Priority Data
Aug. 2, 2024 (KR) 10-2024-0103070

(51) Int. Cl. H04R 1/02; B60R 11/00; B60R 11/02; H04R 17/00

(52) U.S. Cl. CPC H04R 1/026; B60R 11/0217; H04R 1/025; H04R 17/00; B60R 2011/0028; B60R 2011/0047; H04R 2499/13

(57) ABSTRACT

A sound apparatus including an enclosure, a sound generation module including a vibration member and a vibration device connected to the vibration member, a supporting member located on the enclosure, a coupling member contacting an edge of the vibration member and coupled to the enclosure, and a fixing member coupled to the coupling member, and a transportation apparatus including the same.

### CROSS-REFERENCE TO RELATED APPLICATION

Pursuant to 35 U.S.C. § 119 (a), this application claims the benefit of an earlier filing date and right of priority to Korean Patent Application No. 10-2024-0103070, filed on Aug. 2, 2024, the disclosure of which is incorporated herein by reference in its entirety.

### TECHNICAL FIELD

The present specification relates to a sound apparatus and a transportation apparatus comprising the same.

### BACKGROUND

The sound apparatus is being applied to various electronic devices such as TVs, mobile phones, laptops, and tablets.

A vehicle may include a sound apparatus that outputs sound according to audio signals output from multimedia devices such as car audio. For example, the sound apparatus applied to a vehicle may include front speakers and rear speakers configured as a coil method. For example, the speaker may be an actuator including a magnet and a coil.

### SUMMARY

A sound apparatus in a vehicle may output stereophonic sound by using an increased number of speakers, but due to size, weight, and spatial constraints of speakers that implement coil-based structures, there is a limit to increasing the number of speakers for vehicle applications.

An objective of the present specification according to an implementation is to provide a sound apparatus and a transportation apparatus including the same that may improve sound characteristics and/or sound pressure characteristics.

The objectives to be solved by the implementations of this specification are not limited to the objectives mentioned above, and other objectives not mentioned will be clearly understood by those skilled in the art from the following descriptions.

The sound apparatus according to an implementation of the present specification may include an enclosure, a sound generation module including a vibration member and a vibration device connected to the vibration member, a supporting member located on the enclosure, a coupling member contacting an edge of the vibration member and coupled to the enclosure, and a fixing member coupled to the coupling member.

The transportation apparatus according to an implementation of the present specification may include an interior material exposed to an indoor space; and at least one sound apparatus located on the interior material and outputting sound to the indoor space. The sound apparatus may include an enclosure, a sound generation module including a vibration member and a vibration device connected to the vibration member, a supporting member located on the enclosure to support the sound generation module, a coupling member contacting an edge of the vibration member and coupled to the enclosure, and a fixing member coupled to the coupling member.

The sound apparatus and the transportation apparatus comprising the same according to one or more implementations of the present specification may improve sound characteristics and/or sound pressure characteristics by implementing stereophonic sound in the interior of a vehicle using piezoelectric element vibration generators.

The sound apparatus and the transportation apparatus comprising the same according to one or more implementations of the present specification may achieve weight reduction compared to coil-type speakers while implementing a compact size using vibration generators such as piezoelectric elements. For example, the sound apparatus may improve design freedom for the placement of the sound apparatus through weight reduction and compact sizing using vibration generators such as piezoelectric elements, and through the improvement of design freedom, various stereophonic sounds may be implemented in the interior of the transportation apparatus.

The sound apparatus according to one or more implementations of the present specification may facilitate maintenance through a modularized sound generation module. Also, the sound apparatus may facilitate transportation through the fixing member. Also, the sound apparatus may be firmly fixed to the transportation apparatus through the fastening member and bracket provided for fastening between the sound generation module and the fixing member.

The effects of the present specification are not limited to the effects mentioned above, and other effects not mentioned will be clearly understood by those skilled in the art to which the technical idea of the present specification belongs from the following description.

### BRIEF DESCRIPTION OF THE DRAWINGS

The above and other objects, features, and advantages of the present specification will become more apparent to those of ordinary skill in the art by describing example implementations thereof in detail with reference to the attached drawings, in which:

FIG. 1 is a diagram illustrating an example of a sound apparatus according to an implementation of the present specification and a transportation apparatus in which the sound apparatus is located;

FIG. 2 is a diagram illustrating an example of an arrangement relationship between a roof panel and a head liner of a transportation apparatus, and a sound apparatus according to an implementation of the present specification;

FIG. 3 is a perspective view illustrating an example of a sound apparatus according to an implementation of the present specification located on a head liner of a transportation apparatus according to an implementation of the present specification;

FIG. 4 is a cross-sectional view along line I-I′ of FIG. 3.

FIG. 5 is a perspective view illustrating an example of a sound apparatus according to an implementation of the present specification;

FIG. 6 is an exploded perspective view illustrating an example of a sound apparatus according to an implementation of the present specification;

FIG. 7 is a cross-sectional view along line II-II′ of FIG. 5;

FIG. 8 is a perspective view illustrating an example of an enclosure of a sound apparatus according to an implementation of the present specification;

FIG. 9 is a cross-sectional view illustrating an example of an enclosure of a sound apparatus according to an implementation of the present specification;

FIG. 10 is a rear perspective view illustrating an example of a sound generation module of a sound apparatus according to an implementation of the present specification;

FIG. 11 is a side view illustrating an example of a sound generation module of a sound apparatus according to an implementation of the present specification;

FIG. 12 is a diagram illustrating an example of a vibration device according to an implementation of the present specification;

FIG. 13 is a cross-sectional view along line II-II′ of FIG. 12 according to an implementation of the present specification;

FIG. 14 is a cross-sectional view along line III-III′ of FIG. 12 according to an implementation of the present specification;

FIG. 15 is a diagram illustrating an example of a vibration part according to another implementation of the present specification;

FIG. 16 is a diagram illustrating an example of a vibration part according to another implementation of the present specification;

FIG. 17 is a graph illustrating an example of sound pressure characteristics according to a material of a supporting member of a sound apparatus according to an implementation of the present specification;

FIG. 18 is a graph illustrating an example of total harmonic distortion characteristics according to the material of a supporting member of a sound apparatus according to an implementation of the present specification;

FIG. 19 is a rear perspective view illustrating an example of a coupling member of a sound apparatus according to an implementation of the present specification;

FIG. 20 is a plan view illustrating an example of a coupling member of a sound apparatus according to an implementation of the present specification;

FIG. 21 is a cross-sectional view illustrating an example of a coupling member of a sound apparatus according to an implementation of the present specification;

FIG. 22 is a diagram illustrating an example of another implementation of a fixing member of a sound apparatus according to an implementation of the present specification;

FIG. 23 is a perspective view illustrating an example of a sound apparatus according to another implementation of the present specification;

FIG. 24 is an exploded perspective view illustrating an example of a sound apparatus according to another implementation of the present specification;

FIG. 25 is a cross-sectional view illustrating an example of a sound apparatus according to another implementation of the present specification;

FIG. 26 is a perspective view illustrating an example of a sound apparatus according to another implementation of the present specification;

FIG. 27 is an exploded perspective view illustrating an example of a sound apparatus according to another implementation of the present specification;

FIG. 28 is a cross-sectional view illustrating an example of a sound apparatus according to another implementation of the present specification;

FIG. 29 is a rear perspective view illustrating an example of a coupling member of a sound apparatus according to another implementation of the present specification;

FIG. 30 is a plan view illustrating an example of a coupling member of a sound apparatus according to another implementation of the present specification;

FIG. 31 is a rear perspective view illustrating an example of another implementation of a coupling member located in a sound apparatus according to another implementation of the present specification;

FIG. 32 is a plan view illustrating an example of another implementation of a coupling member located in a sound apparatus according to another implementation of the present specification; and

FIG. 33 is a diagram illustrating an example of a transportation apparatus according to an implementation of the present specification.

### DETAILED DESCRIPTION

The advantages and features of the present disclosure and methods for accomplishing the same will be more clearly understood from implementations described below with reference to the accompanying drawings. However, the present disclosure is not limited to the following implementations but may be implemented in various different forms. Rather, the present implementations will make the disclosure of the present disclosure complete and allow those skilled in the art to completely comprehend the scope of the present disclosure.

Shapes, sizes, ratios, angles, numbers, and the like disclosed in the drawings for describing the implementations of the present disclosure are example, and the present disclosure is not limited to the illustrated items. Like reference numerals refer to like elements throughout. In addition, in describing the present disclosure, if it is determined that the detailed description of the related known technology may unnecessarily obscure the subject matter of the present disclosure, the detailed description thereof will be omitted. The terms such as “comprising”, “including”, “having” and “consisting of” used herein are generally intended to allow other components to be added unless the terms are used with the term “only”. References to the singular shall be construed to include the plural unless expressly stated otherwise.

In interpreting a component, it is interpreted to include an error range even if there is no separate description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

When describing a temporal contextual relationship is described, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to below may be a second component within the technical spirit of the present disclosure.

Terms such as first, second, A, B, (a), (b), and the like may be used to describe elements of the implementations of the present specification. Such terms are intended only to distinguish one component from another and are not intended to define the nature, sequence, order, or number of such components.

When a component is described as “connected,” “coupled,” or “attached” to another component, it is to be understood that the component may be directly connected or attached to the other component, but that there may also be other components “interposed” between the respective components which may be indirectly connected or attached where not specifically stated.

When a component or layer is described as “contacting” or “overlapping” another component or layer, the component or layer may directly contact or overlap the other component or layer, but unless there is a specific statement, it should be understood that other components may be interposed between the components that are indirectly contacting or overlapping.

“At least one” should be understood to include all combinations of one or more of the associated components. For example, the meaning of “at least one of first, second, and third components” includes not only the first, second, or third component but also all combinations of two or more of all components among the first, second, and third components.

“First direction,” “second direction,” “third direction,” “X-axis direction,” “Y-axis direction,” and “Z-axis direction” should not be interpreted only as geometric relationships that are perpendicular to each other, but may mean a broader directionality within the range that the configuration of the present specification may function.

The features of the various implementations of the present specification may be partially or entirely combined or combined with each other, and may be technically interlocked and driven in various ways, and the implementations may be carried out independently of each other or may be carried out in an associated relationship.

Hereinafter, various implementations of the present specification will be described in detail with reference to the accompanying drawings.

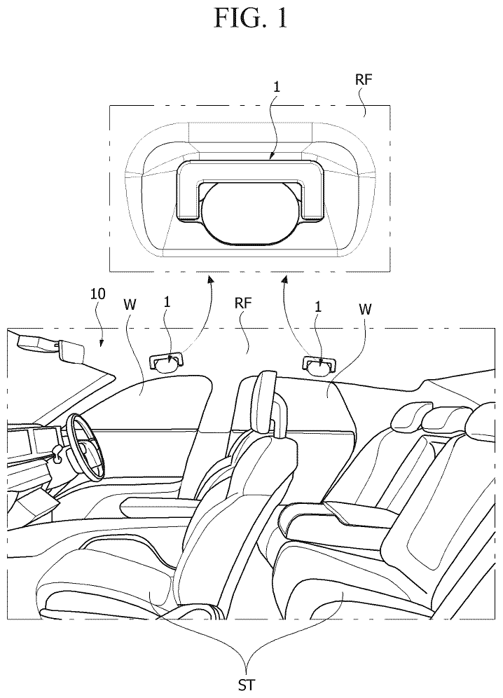

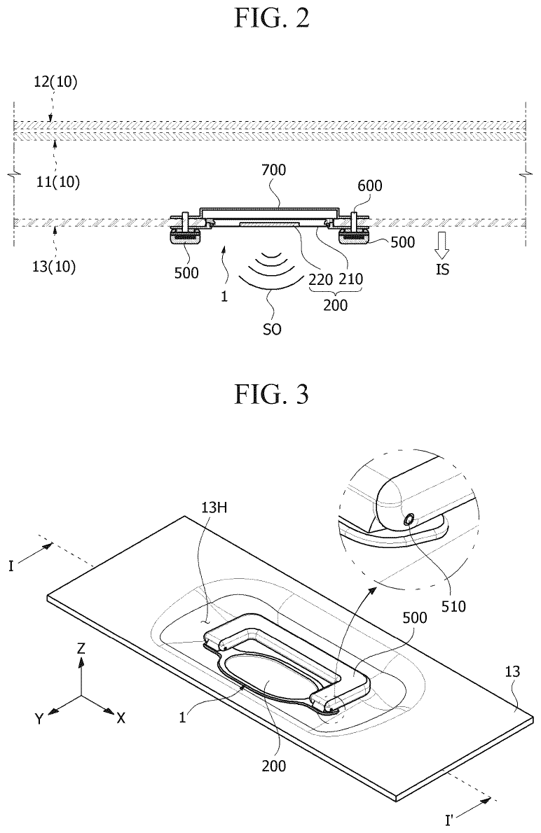

FIG. 1 is a diagram illustrating a sound apparatus according to an implementation of the present specification and a transportation apparatus in which the sound apparatus is located. FIG. 2 is a diagram illustrating an arrangement relationship between a roof panel and a head liner of a transportation apparatus, and a sound apparatus according to an implementation of the present specification.

Referring to FIGS. 1 and 2, a transportation apparatus according to an implementation of the present specification may include a sound apparatus 1. As an example, the sound apparatus 1 may be located on a ceiling RF of a vehicle interior. The transportation apparatus may be a vehicle 10 including one or more seats ST and one or more windows or window W. The vehicle 10 may be an automobile, a train, a ship, or an aircraft, etc., and the implementations of the present specification are not limited thereto.

The sound apparatus 1 may be located or mounted inside the vehicle 10 to output sound SO toward an indoor space IS of the vehicle 10.

The vehicle 10 according to an implementation of the present specification may include a main structure 11.

The main structure 11 of the vehicle 10 may include a main frame, a sub frame, a side frame, a door frame, an under frame, and a seat frame, etc., and the implementations of the present specification are not limited thereto. For example, the main structure 11 may be a vehicle body, a vehicle structure, or a frame structure, etc., and the implementations of the present specification are not limited thereto.

The vehicle 10 according to an implementation of the present specification may further include an exterior material 12.

The exterior material 12 of the vehicle 10 may be configured to cover the main structure 11. For example, based on the interior of the vehicle 10, the exterior material 12 may be configured to cover the outside of the main structure 11. In the following description, the exterior material 12 may be a vehicle exterior material 12, and these terms may be used interchangeably.

The exterior material 12 of the vehicle 10 may include a hood panel, a front fender panel, a dash panel, a pillar panel, a trunk panel, a roof panel (or ceiling), a floor panel, a door inner panel, and a door outer panel, etc., and the implementations of the present specification are not limited thereto. For example, considering the example of a fixing member (e.g., handle) located on the sound apparatus 1, the exterior material 12 of the vehicle 10 may be a roof panel.

The exterior material 12 according to an implementation of the present specification may include at least one of a flat part and a curved part (or bent part). For example, the exterior material 12 may have a structure corresponding to the structure of the corresponding main structure 11, or may have a structure different from the structure of the main structure 11.

The vehicle 10 according to an implementation of the present specification may further include an interior material 13. In the following description, the interior material 13 may be a vehicle interior material 13, and these terms may be used interchangeably.

The interior material 13 of the vehicle 10 may include all parts constituting the interior of the vehicle 10 or all parts located in the indoor space IS of the vehicle 10. For example, the vehicle interior material 13 may be an interior material or interior finish material of the vehicle 10, and the implementations of the present specification are not limited thereto. For example, considering the example of a fixing member (e.g., handle) located on the sound apparatus 1, the interior material 13 may be a headliner of the vehicle 10.

The vehicle interior material 13 according to an implementation of the present specification may be configured to cover at least one of the main structure 11 and the exterior material 12 in the indoor space IS of the vehicle 10. For example, the interior material 13 may be configured to be exposed to the indoor space IS of the vehicle 10 while covering at least one of the main structure 11 and the exterior material 12 in the indoor space IS of the vehicle 10.

The interior material 13 according to an implementation of the present specification may be exposed to the interior and/or the indoor space IS of the vehicle 10. For example, the interior material 13 may be configured to cover at least one surface or interior surface of the main frame (or vehicle body), side frame (or side body), door frame (or door body), handle frame (or steering hub), and seat frame exposed to the indoor space IS of the vehicle 10.

The interior material 13 of the vehicle 10 according to an implementation of the present specification may include a dash board, a pillar interior material (or pillar trim), a floor interior material (or floor carpet), a roof interior material (or headliner), a door interior material (or door trim), a handle interior material (or steering cover), a seat interior material, a rear package interior material (or rear seat shelf), an overhead console (or interior lighting interior material), a rear view mirror, a glove box, and a sun visor, etc., and the implementations of the present specification are not limited thereto. For example, considering the example placement position of the fixing member (e.g., handle) located on the sound apparatus 1, the interior material 13 may be a headliner of the vehicle 10.

The interior material 13 of the vehicle 10 according to an implementation of the present specification may include one or more materials among metal, wood, rubber, plastic, glass, fiber, cloth, paper, mirror, leather, and carbon, and the implementations of the present specification are not limited thereto. The interior material 13 of plastic material may be an injection molded product implemented by an injection process using thermoplastic resin or thermosetting resin, and the implementations of the present specification are not limited thereto. The interior material 13 of fiber material may include at least one of plastic composite fiber, carbon fiber or aramid fiber, and natural fiber, and the implementations of the present specification are not limited thereto. The interior material 13 of fiber material may be a woven sheet, a knit sheet, or a non-woven fabric, etc., and the implementations of the present specification are not limited thereto. For example, the interior material 13 of fiber material may be a fabric member, and the implementations of the present specification are not limited thereto. For example, paper may be cone paper for speakers. For example, cone paper may be pulp or foamed plastic, etc., but the implementations of the present specification are not limited thereto. The vehicle interior material 13 of leather material may include natural leather or artificial leather, and the implementations of the present specification are not limited thereto. For example, the natural fiber may be Jute fiber, Kenaf fiber, Abaca fiber, coconut fiber, and wood fiber, or a mixture of one or more of them, and the implementations of the present specification are not limited thereto.

The interior material 13 according to an implementation of the present specification may include at least one of a flat part and a curved part (or bent part). For example, the interior material 13 may have a structure corresponding to the structure or internal surface structure of the corresponding main structure 11, or may have a structure different from the structure of the corresponding main structure 11. For example, considering the convenience of passengers riding in the vehicle 10, the interior material 13 may be formed to have a structure different from the structure of the main structure 11 or the structure of the exterior material 12. For example, differently from the structure of the main structure 11 or the structure of the exterior material 12, the interior material 13 may include a concave groove, and the sound apparatus 1 may be located in the groove. The groove formed in the interior material 13 may be formed in various shapes, and the implementations of the present specification are not limited thereto.

The sound apparatus 1 according to an implementation of the present specification may be located on the interior material 13 of the vehicle 10. For example, the sound apparatus 1 may be located to penetrate the interior material 13, and may generate sound SO toward the indoor space IS of the vehicle 10. For example, a part of the sound apparatus 1 may be exposed to the indoor space IS, and a part of the sound apparatus 1 may be located in a space between the exterior material 12 and the interior material 13. The interior material 13 of the vehicle 10 may have a size larger than the sound apparatus 1, and the implementations of the present specification are not limited thereto.

The vehicle 10 according to an implementation of the present specification may include at least one sound apparatus 1. By generating sound SO through at least one of at least one sound apparatus 1 located on the interior material 13 of the vehicle 10, realistic sound SO including a multi-channel and/or stereophonic sound may be output toward the indoor space IS of the vehicle 10.

According to an implementation of the present specification, the sound apparatus 1 may be configured in an area between the interior material 13 and the main structure 11 of the vehicle 10 or in an area between the interior material 13 and the exterior material 12 of the vehicle 10.

According to an implementation of the present specification, the sound apparatus 1 may be located in at least one of an area between the main structure 11 and the exterior material 12 of the vehicle 10, an area between the main structure 11 and the interior material 13 of the vehicle 10, the exterior material 12, and the interior material 13. For example, the sound apparatus 1 may be located in at least one of an area between the main structure 11 and the exterior material 12 of the vehicle 10, an area between the main structure 11 and the interior material 13 of the vehicle 10, the exterior material 12 of the vehicle 10, and the interior material 13 of the vehicle 10, and configured to output sound.

For example, the sound apparatus 1 may be located in at least one of the exterior material 12 of the vehicle 10, the interior material 13, and between the exterior material 12 and the interior material 13. According to an implementation of the present specification, at least one of the exterior material 12 of the vehicle 10, the interior material 13, and between the exterior material 12 and the interior material 13 may support the sound apparatus 1.

The sound apparatus 1 according to an implementation of the present specification may output sound SO from the interior material 13 of the vehicle 10. For example, the sound apparatus 1 may be connected or coupled to at least one of the exterior material 12 and the interior material 13 between the exterior material 12 and the interior material 13 of the vehicle 10, and may output sound by indirectly or directly vibrating at least one of the exterior material 12 and the interior material 13 of the vehicle 10.

At least one of the exterior material 12 and the interior material 13 of the vehicle 10 may also be used as a vibration plate, a sound vibration plate, or a sound generation plate, etc. for sound output. For example, each of the exterior material 12 and the interior material 13 of the vehicle 10 for sound output has a size larger than the sound apparatus 1, so that by functioning as a large-area vibration plate, sound vibration plate, or sound generation plate, it may improve sound characteristics and/or sound pressure characteristics of the sound including the low frequency band generated by the sound apparatus 1. For example, the frequency of the low frequency band sound may be 300 Hz or less, 400 Hz or less, or 500 Hz or less, and the implementations of the present specification are not limited thereto.

Referring to FIG. 2, the sound apparatus 1 may be located on the interior material 13. For example, the sound apparatus 1 may use a fastening member 600 and a bracket 700 for coupling with the headliner provided as the interior material 13. For example, the fastening member 600 penetrating a part of the sound apparatus 1 may penetrate the interior material 13 and then couple with the bracket 700. Accordingly, the sound apparatus 1 may be coupled to the interior material 13.

Therefore, a plurality of sound apparatuses 1 may improve sound characteristics and/or sound pressure characteristics by implementing stereophonic sound in the indoor space IS of the vehicle by generating sound SO output to the indoor space IS through the sound generation module 200 while coupled to the headliner of the vehicle. For example, the sound apparatus 1 may generate sound SO output to the indoor space IS according to the vibration of the vibration device 220 of the sound generation module 200 that vibrates the vibration member 210. Accordingly, the vibration member 210 may generate sound SO output to the indoor space IS by outputting sound or sound waves according to the displacement or driving of the vibration device 220.

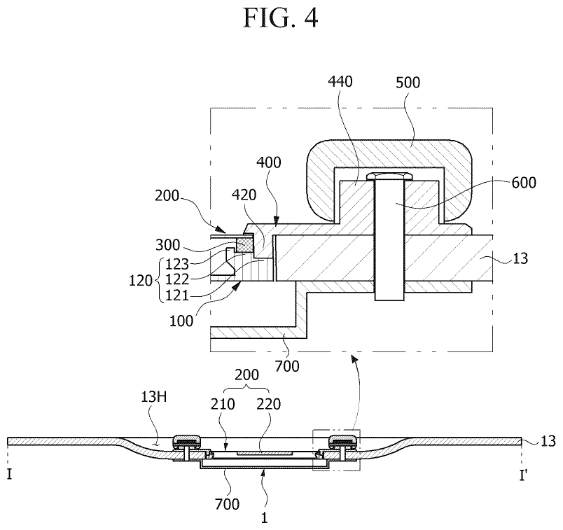

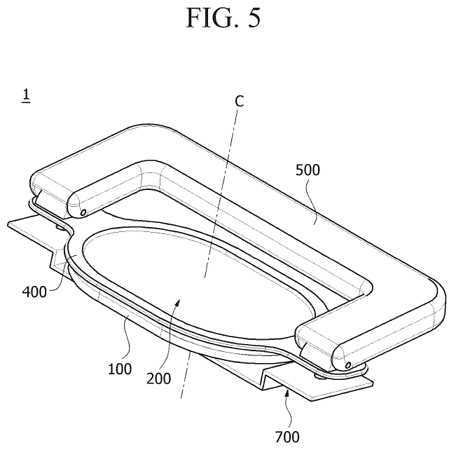

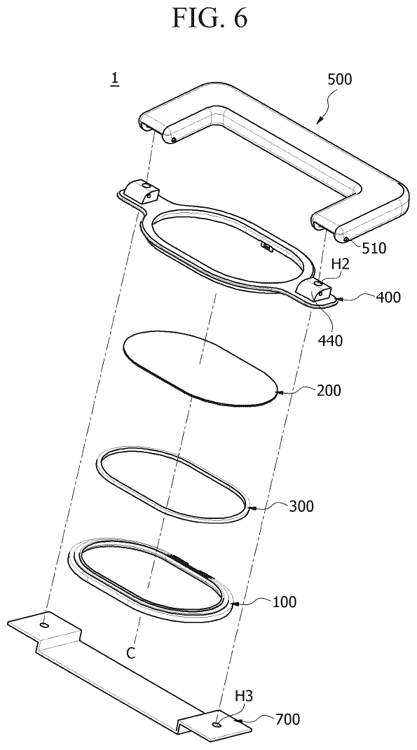

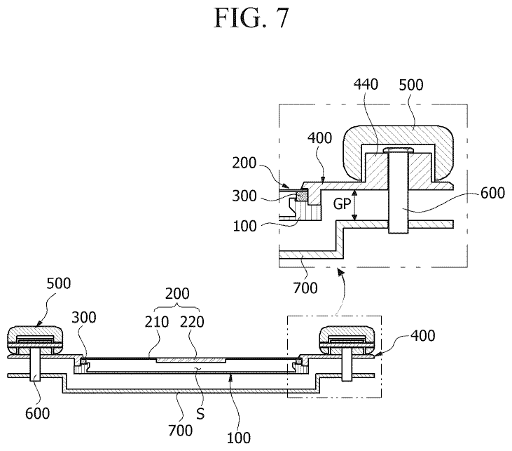

FIG. 3 is a perspective view illustrating a sound apparatus according to an implementation of the present specification located on a head liner of a transportation apparatus according to an implementation of the present specification. FIG. 4 is a cross-sectional view along line I-I′ of FIG. 3. FIG. 5 is a perspective view illustrating a sound apparatus according to an implementation of the present specification. FIG. 6 is an exploded perspective view illustrating a sound apparatus according to an implementation of the present specification. FIG. 7 is a cross-sectional view along line II-II′ of FIG. 5.

The sound apparatus 1 may be a rectangular structure having a length in the X-axis direction, a width in the Y-axis direction, and a thickness in the Z-axis direction. The shape of the sound apparatus 1 illustrated in FIGS. 3 to 7 is merely an example, and the implementations of the present specification are not limited thereto. For example, the sound apparatus 1 may be a circular structure having a predetermined thickness. The X-axis direction shown in FIG. 3 may mean the length direction or horizontal direction, the Y-axis direction may mean the width direction or vertical direction, and the Z-axis direction may mean the up-down direction, vertical direction, or thickness direction. The X-axis direction, Y-axis direction, and Z-axis direction may be perpendicular to each other, but may also mean different directions that are not perpendicular to each other. Accordingly, each of the X-axis direction, Y-axis direction, and Z-axis direction may be described as any one of the first direction, the second direction, and the third direction. Also, a plane extending in the X-axis direction and the Y-axis direction may be a horizontal plane. Also, the X-axis direction and the Y-axis direction may be one of the horizontal directions. The reference symbol ‘C’ shown in FIGS. 6 and 7 may indicate the center of the sound apparatus 1 on the horizontal plane.

The sound apparatus 1 may be coupled to a headliner provided as the interior material 13. For example, as shown in FIGS. 3 and 4, the sound apparatus 1 may be located in a groove 13H formed concavely in the interior material 13, but is not necessarily limited thereto.

Referring to FIGS. 3 to 7, the sound apparatus 1 according to an implementation of the present specification may include an enclosure 100, a sound generation module 200, a supporting member 300, and a coupling member 400.

The sound apparatus 1 may include a fixing member (e.g., handle) 500 located (e.g., rotatably located) on the coupling member 400. For example, through a shaft 510, the handle 500 may be rotatably located on a protrusion part 440 of the coupling member 400. For example, the coupling member 400 may prevent the sound generation module 200 from being detached. In these examples, the fixing member 500 is implemented by a handle, but the implementations of the present specification are not limited thereto.

The sound apparatus 1 may further include a fastening member 600 and a bracket 700. The sound apparatus 1 may be provided to a user in a modularized form, and the sound apparatus 1 may be located on a headliner provided as the interior material 13 using the fastening member 600 and the bracket 700, but the implementations of the present specification are not limited thereto. For example, the sound apparatus 1 may be coupled to the interior material 13 by the fastening member 600 and the bracket 700. For example, the bracket 700 is located to be spaced apart from the coupling member 400 to have a predetermined gap GP, so the interior material 13 may be located in the gap GP (see FIG. 7). Accordingly, the fastening member 600 penetrating the second hole H2 of the coupling member 400 may penetrate the interior material 13 and then couple to the third hole H3 of the bracket 700 (see FIGS. 4, 6, and 7). In another example, the sound apparatus 1 may also be located on a headliner provided as the interior material 13 without using the fastening member 600 and the bracket 700.

According to an implementation of the present specification, the enclosure 100 may be located adjacent to the sound generation module 200.

The enclosure 100 may be located between the exterior material 12 and the interior material 13, but is not necessarily limited thereto.

The enclosure 100 according to an implementation of the present specification may include one or more materials among metal material or non-metal material or composite non-metal material, but the implementations of the present specification are not limited thereto. For example, the enclosure 100 may include one or more materials among metal material, plastic, fiber, carbon, and wood, but the implementations of the present specification are not limited thereto. For example, the enclosure 100 may be composed of a metal material of aluminum material, or may be composed of a plastic material of plastic or styrene material, but the implementations of the present specification are not limited thereto. For example, the styrene material may be ABS material. The ABS material may be Acrylonitrile, Butadiene, and Styrene.

The enclosure 100 may be configured to be connected (or coupled) to the interior material 13. The enclosure 100 may be configured to support or house (or accommodate) the sound generation module 200.

The enclosure 100 may be configured to vibrate according to the driving (or vibration or displacement) of the sound generation module 200. For example, the enclosure 100 may be configured to vibrate the interior material 13 according to the driving (or vibration or displacement) of the sound generation module 200. For example, the enclosure 100 may be a housing, a case, an outer case, a case member, a housing member, a cabinet, a sealing member, a sealing cap, a sealing box, or a sound box, etc., and the implementations of the present specification are not limited thereto.

The enclosure 100 may include an internal space S. For example, the enclosure 100 may be formed in a tubular shape including an internal space S inside, but the implementations of the present specification are not limited thereto.

The enclosure 100 may be located facing the sound generation module 200 with the internal space S between them. For example, the enclosure 100 may be behind the sound generation module 200 with the internal space S between them. For example, the enclosure 100 may be configured to cover the sound generation module 200 with the internal space S between them. For example, the enclosure 100 may be configured to cover the first surface (or back surface, rear surface or bottom surface) of the sound generation module 200. For example, the enclosure 100 may support the sound generation module 200 through the supporting member 300 with the internal space S between them. For example, the enclosure 100 may be configured to support or cover the first surface (or back surface, rear surface or bottom surface) of the sound generation module 200.

For example, the internal space S of the enclosure 100 may be between the sound generation module 200 and the enclosure 100. For example, the internal space S may be between the first surface of the vibration member 210 and the enclosure 100. For example, the internal space S may be between the vibration device 220 and the enclosure 100. For example, the sound generation module 200 may also be located in the internal space S of the enclosure 100, but is not necessarily limited thereto. For example, the vibration device 220 of the sound generation module 200 may be in the internal space S of the enclosure 100. For example, the internal space S of the enclosure 100 may be an accommodation space, a housing space, a gap space, an air space, a vibration space, a sound space, a resonance chamber, or a sealed space, etc., and the implementations of the present specification are not limited thereto.

According to the present specification, the vibration device 220 may be located toward the internal space S of the enclosure 100. For example, depending on the thickness of the supporting member 300, the vibration device 220 may also be located in the internal space S of the enclosure 100.

According to the present specification, the vibration member 210 may cover the internal space S of the enclosure 100. Accordingly, the vibration device 220 connected to the vibration member 210 may be located in the internal space S of the enclosure 100. For example, the vibration member 210 may be formed in a plate shape and located on the supporting member 300 located on the enclosure 100, so that the vibration member 210 may cover the internal space S of the enclosure 100. For example, by adjusting the thickness of the supporting member 300, the vibration member 210 may cover the internal space S of the enclosure 100. Accordingly, the vibration device 220 may be located in the internal space S of the enclosure 100.

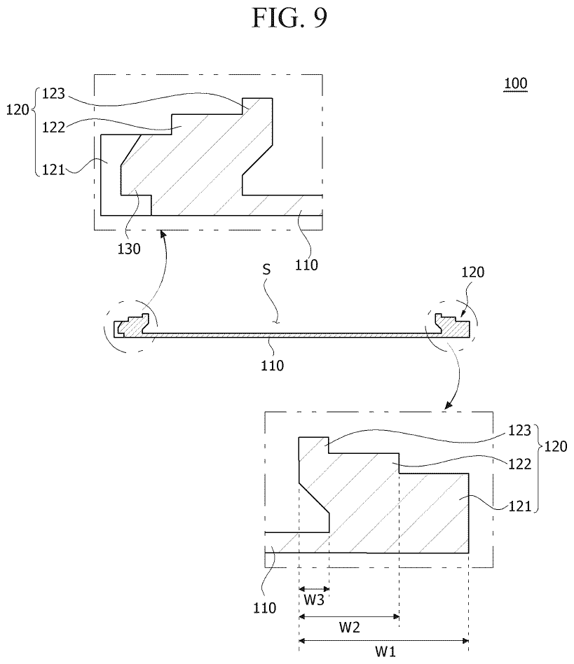

Referring to FIG. 4, the enclosure 100 may include an enclosure sidewall 120. The enclosure sidewall 120 may include a first sidewall part 121, a second sidewall part 122, and a third sidewall part 123. This will be described later with reference to FIG. 9.

According to the present specification, the supporting member 300 may be located on the enclosure 100. For example, the supporting member 300 may support the sound generation module 200.

The enclosure 100 may be connected to the sound generation module 200 via the supporting member 300 with the internal space S between them. The enclosure 100 may be located or connected to the first surface side (or back surface side, rear surface side or bottom surface side) of the sound generation module 200 with the internal space S between them. For example, the enclosure 100 may be connected (or coupled) to the edge portion of the first surface of the sound generation module 200 via the supporting member 300 with the internal space S between them. The enclosure 100 may support the first surface of the sound generation module 200 via the supporting member 300 with the internal space S between them. For example, the enclosure 100 may be configured to surround the first surface of the sound generation module 200. The enclosure 100 may be configured to cover the first surface of the sound generation module 200.

According to the present specification, the coupling member 400 may be coupled (or connected) to the enclosure 100. For example, the coupling member 400 may prevent the sound generation module 200 from being detached.

The sound apparatus 1 may include a fixing member (e.g., handle) 500 rotatably located on the coupling member 400. The coupling member 400 may further include a shaft 510 and a protrusion part 440. For example, the handle 500 may be rotatably located on the protrusion part 440 of the coupling member 400 through the shaft 510, but the implementations of the present specification are not limited thereto.

The sound apparatus 1 may further include a fastening member 600 and a bracket 700. For example, the sound apparatus 1 may be coupled to the interior material 13 by the fastening member 600 and the bracket 700. For example, the bracket 700 is located to be spaced apart from the coupling member 400 to have a predetermined gap GP, so the interior material 13 may be located in the gap GP (see FIG. 7). Accordingly, the fastening member 600 penetrating the second hole H2 of the coupling member 400 may penetrate the interior material 13 and then couple to the third hole H3 of the bracket 700 (see FIGS. 4, 6, and 7). Thus, the sound apparatus 1 may be provided to a user in a modularized form, and the sound apparatus 1 may be located on a headliner provided as the interior material 13 using the fastening member 600 and the bracket 700, but the implementations of the present specification are not limited thereto. In another example, the sound apparatus 1 may also be located on a headliner provided as the interior material 13 without using the fastening member 600 and the bracket 700.

The enclosure 100 may be connected (or coupled) to the interior material 13 of the vehicle 10. For example, the enclosure 100 may be located or coupled in a hole formed in the interior material 13 of the vehicle 10. For example, a hole may be formed in the interior material 13 of the vehicle 10 so that the enclosure 100 may be located to penetrate the interior material 13 of the vehicle 10, and the enclosure 100 may be located in the hole of the interior material 13. Accordingly, the enclosure 100 may penetrate the interior material 13 of the vehicle 10.

The enclosure 100 may be vibrated according to the driving (or vibration or displacement) of the sound generation module 200, and the interior material 13 of the vehicle 10 may vibrate according to the vibration of the enclosure 100 to generate or output sound. Thereby, as sound is generated according to the vibration of the interior material 13 of the vehicle 10 having a size larger than the sound apparatus 1, the sound characteristics and/or sound pressure characteristics of the sound band including the low frequency band generated by the driving (or vibration or displacement) of the sound apparatus 1 may be improved.

The vibration device 220 of the sound generation module 200 vibrates the vibration member 210 to generate sound (or sound pressure or sound wave) in the internal space S of the enclosure 100, and thereby the enclosure 100 may be vibrated, and the interior material 13 of the vehicle 10 may vibrate according to the vibration of the enclosure 100 to generate (or output) sound. For example, the interior material 13 of the vehicle 10 may generate (or output) sound in conjunction with the vibration of the enclosure 100 according to the sound (or sound pressure or sound wave) generated in the internal space S of the enclosure 100.

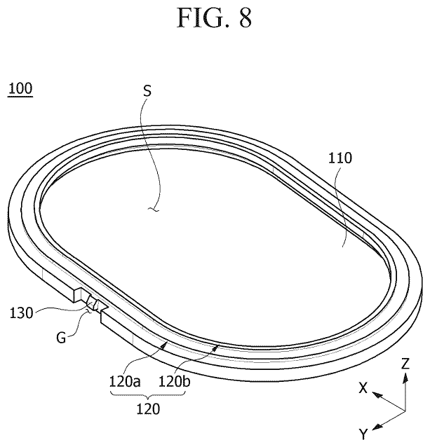

FIG. 8 is a perspective view illustrating an enclosure of a sound apparatus according to an implementation of the present specification. FIG. 9 is a cross-sectional view illustrating an enclosure of a sound apparatus according to an implementation of the present specification.

Referring to FIGS. 8 and 9, the enclosure 100 may include an enclosure body 110 and an enclosure sidewall 120.

The enclosure body 110 and the enclosure sidewall 120 may be integrally configured. As a result, the vibration of the enclosure 100 according to the sound (or sound pressure or sound wave) generated in the internal space S of the enclosure 100 may be transmitted to the interior material 13 without loss of sound, and the coupling with the coupling member 400 may also be firmly made. For example, since the enclosure body 110 and the enclosure sidewall 120 are integrally configured, the vibration of the enclosure body 110 may be transmitted to the interior material 13 without loss of sound through the enclosure sidewall 120.

The enclosure body 110 may be configured in a plate shape having a predetermined thickness, but the implementations of the present specification are not limited thereto.

The enclosure sidewall 120 may protrude from the enclosure body 110. For example, the enclosure sidewall 120 may extend protruding from the edge of the enclosure body 110. For example, the enclosure sidewall 120 may be formed to protrude in the Z-axis direction from the edge of the enclosure body 110. For example, the enclosure sidewall 120 may be located toward the coupling member 400. Accordingly, an opening may be formed at the top of the enclosure 100.

The sound apparatus 1 according to an implementation of the present specification may be vulnerable to the internal entry of moisture and/or impurities, etc. as it is located adjacent to the exterior material 12 of the vehicle 10. For example, the sound apparatus 1 may be located between the roof panel as the exterior material 12 of the vehicle 10 and the headliner as the interior material 13 or may be located to be exposed to the space between the exterior material 12 and the interior material 13, so that there is a possibility that moisture and/or impurities, etc. entering the space between the exterior material 12 and the interior material 13 may enter the inside of the sound apparatus 1. For example, when a structure such as a sunroof, etc. penetrating the exterior material 12 and the interior material 13 and the sound apparatus 1 are located adjacent to each other, there is a possibility that moisture and impurities, etc. may enter the inside of the sound apparatus 1. Even if the enclosure body 110 and the enclosure sidewall 120 are integrally formed, the enclosure 100 is a structure that couples with the coupling member 400, so moisture and/or impurities, etc. may enter the inside through the gap between the enclosure 100 and the coupling member 400. Accordingly, the enclosure sidewall 120 coupled to the coupling member 400 constitutes at least one step to prevent or minimize the entry of moisture and/or impurities, etc. into the inside of the sound apparatus 1.

The enclosure 100 may include the enclosure sidewall 120. At least one step structure may be implemented on the enclosure sidewall 120. Thereby, a waterproof and dustproof structure may be applied to the enclosure 100. The step structure may prevent or minimize the entry of moisture and impurities, etc. into the inside of the sound apparatus 1.

Referring to FIG. 8, the enclosure sidewall 120 may include a first portion 120a and a second portion 120b. For example, the first portion 120a and the second portion 120b may be configured to have steps. For example, the first portion 120a may be a first step part, and the second portion 120b may be a second step part, but the implementations of the present specification are not limited thereto.

The height of the first portion 120a may be formed smaller than the height of the second portion 120b with respect to the enclosure body 110. Due to the height difference between the first portion 120a and the second portion 120b, the enclosure sidewall 120 may include at least 2 step structures, but the implementations of the present specification are not limited thereto. The second portion 120b may be located more inward than the first portion 120a. Accordingly, the enclosure sidewall 120 having at least two step structures may prevent or minimize the entry of moisture and/or impurities, etc. into the internal space S of the enclosure 100. Here, inward may indicate a direction toward the center C, and outward may indicate a direction opposite to the inward direction.

The first portion 120a may support the coupling member 400. The second portion 120b may support the supporting member 300.

Referring to FIGS. 4 and 9 together, the enclosure sidewall 120 may include a first sidewall part 121, a second sidewall part 122, and a third sidewall part 123.

The first sidewall part 121 may protrude in the Z-axis direction from the edge of the enclosure body 110. The sidewall part 420 of the coupling member 400 may be located on the first sidewall part 121. For example, the first sidewall part 121 may overlap with the sidewall part 420 of the coupling member 400 in the Z-axis direction.

The second sidewall part 122 may protrude in the Z-axis direction from the first sidewall part 121 to implement a step structure. Accordingly, the second sidewall part 122 may support the sidewall part 420 of the coupling member 400. Also, the supporting member 300 may be located on the second sidewall part 122. For example, the second sidewall part 122 may overlap with the supporting member 300 in the Z-axis direction.

The third sidewall part 123 may protrude in the Z-axis direction from the second sidewall part 122 to implement a step structure. Accordingly, the third sidewall part 123 may support the supporting member 300. For example, the third sidewall part 123 may overlap with the supporting member 300 in the horizontal direction, and may be located on the inner side of the supporting member 300 to support the supporting member 300. For example, considering the elastic deformation of the supporting member 300, the end of the third sidewall part 123 may be located to be spaced apart from the vibration member 210.

The third width W3 of the third sidewall part 123 may be formed smaller than the second width W2 of the second sidewall part 122, and the second width W2 of the second sidewall part 122 may be formed smaller than the first width W1 of the first sidewall part 121 to configure a step structure in the enclosure sidewall 120.

The first sidewall part 121, the second sidewall part 122, and the third sidewall part 123 with different widths may implement a step structure in the enclosure sidewall 120, and the step structure may prevent or minimize the entry of moisture and/or impurities, etc. into the internal space S of the enclosure 100.

According to the present specification, the supporting member 300 may be configured to connect or couple the vibration member 210 and the enclosure 100 to each other. For example, the supporting member 300 may be between the edge portion of the vibration member 210 and the enclosure 100.

According to an implementation of the present specification, the supporting member 300 may be located or configured on the first surface (or rear surface) of the vibration member 210. The supporting member 300 may be connected (or coupled or contacted) with the first surface of the vibration member 210. For example, the supporting member 300 may be connected (or coupled or contacted) with the edge portion of the first surface of the vibration member 210.

The supporting member 300 may be configured to support the edge portion of the first surface of the vibration member 210. For example, the supporting member 300 may be configured to surround the edge of the first surface of the sound generation module 200. For example, the supporting member 300 may be configured in a shape corresponding to the edge of the vibration member 210. Accordingly, the supporting member 300 may support the edge of the vibration member 210, and may improve the waterproof and dustproof characteristics of the sound apparatus 1. For example, the supporting member 300 may be formed in a ring shape, but is not necessarily limited thereto. For example, the supporting member 300 may be configured in a ring shape including a vertical cross-section of a square shape. For example, the supporting member 300 may be located in contact between the enclosure 100 and the vibration member 210 to support the enclosure 100 and the vibration member 210, and may also be configured to have a vertical cross-section of circular, oval, hexagonal and octagonal, etc. polygonal shapes. The supporting member 300 may be located between the third sidewall part 123 of the enclosure 100 and the sidewall part 420 of the coupling member 400 in the horizontal direction.

The supporting member 300 may be between the vibration member 210 and the enclosure 100. The supporting member 300 may be between the edge portion of the vibration member 210 and the edge portion of the enclosure 100. For example, the supporting member 300 may be between the edge portion of the vibration member 210 and the second sidewall part 122 of the enclosure 100.

The enclosure sidewall 120 may support the first surface of the vibration member 210 via the supporting member 300. For example, the enclosure sidewall 120 may support the edge portion of the first surface of the vibration member 210 through the supporting member 300.

According to an implementation of the present specification, the supporting member 300 may be configured to buffer to minimize or prevent the transmission of the vibration of the vibration member 210 to the enclosure 100. Also, the supporting member 300 may be located between the enclosure 100 and the vibration member 210 to prevent or minimize the entry of moisture and impurities, etc. into the internal space S of the enclosure 100 together with the above-described step structure.

The supporting member 300 may include material characteristics that block or minimize the vibration transmitted from the vibration member 210 to the enclosure 100. The sound characteristics and/or sound pressure characteristics generated according to the vibration of the vibration member 210 may be adjusted by these material characteristics of the supporting member 300. For example, the supporting member 300 may include a material having elasticity. For example, the supporting member 300 may include a material having elasticity for vibration absorption (or shock absorption). The supporting member 300 according to an implementation of the present specification may be composed of polyurethane material, polyolefin material, natural rubber material, foam rubber, etc., but the implementations of the present specification are not limited thereto. For example, for the coupling of the enclosure 100 and/or the vibration member 210 and the supporting member 300, the supporting member 300 may include one or more of adhesive, double-sided adhesive, double-sided tape, double-sided adhesive tape, double-sided foam tape, double-sided adhesive foam tape, double-sided pad, double-sided foam pad, double-sided adhesive foam pad, and double-sided cushion tape, but the implementations of the present specification are not limited thereto. For example, when the enclosure 100 and the vibration member 210 are coupled via the supporting member 300, the entry of moisture and impurities, etc. into the internal space S of the enclosure 100 may be more easily blocked. Accordingly, the adhesive, etc. included in the supporting member 300 may be implemented as one configuration for waterproof and dustproof design.

The enclosure 100 may couple with the coupling member 400 in a fitting manner. For example, the second sidewall part 122 of the enclosure sidewall 120 may couple with the sidewall part 420 of the coupling member 400 in a fitting manner. To improve the coupling force of the fitting manner, the enclosure 100 and the coupling member 400 may also additionally couple using a hook method. For example, the enclosure 100 and the coupling member 400 may couple in a hook manner through a hook coupling using a protrusion and a protrusion, groove, hole, etc. corresponding to the protrusion.

According to the present specification, in case of damage to the sound generation module 200, the sound generation module 200 may be easily replaced due to the detachable coupling between the enclosure 100 and the coupling member 400. For example, since the enclosure 100 and the coupling member 400 couple in a fitting manner, coupling and/or decoupling may be easy. Accordingly, in case of damage to the sound generation module 200, the sound generation module 200 may be easily replaced. Therefore, according to the sound apparatus 1 of the present specification, only the replacement parts may be replaced, so that cost savings may be possible in terms of maintenance costs.

The enclosure 100 and the coupling member 400 may be detachably coupled using at least one of a fitting method, a hook coupling method and/or a coupling method using a fastening member such as a bolt, but are not necessarily limited thereto. For example, the enclosure 100 and the coupling member 400 may also be coupled using an adhesive member.

The enclosure 100 may further include at least one protrusion 130 formed to protrude on the enclosure sidewall 120. The protrusion 130 may be used for coupling the enclosure 100 and the coupling member 400. The enclosure 100 illustrates one protrusion 130 in FIG. 8, but is not necessarily limited thereto. For example, to firmly secure the coupling of the enclosure 100 and the coupling member 400, the enclosure 100 may also include one or more protrusions 130. Here, a protrusion 130 is formed on the enclosure 100 for the hook coupling as an example, but is not necessarily limited thereto. For example, for the hook coupling of the enclosure 100 and the coupling member 400, a protrusion may be formed on the coupling member 400, and a protrusion, groove, hole, etc. for coupling with the protrusion of the coupling member 400 may be formed on the enclosure 100, but the implementations of the present specification are not limited thereto.

Referring to FIGS. 8 and 9, the protrusion 130 may be formed to protrude in the Y-axis direction from the first sidewall part 121, but is not necessarily limited thereto. For example, the protrusion 130 may be formed to protrude in the horizontal direction from the first sidewall part 121. For example, since the horizontal direction includes the X-axis direction, the protrusion 130 may also be formed to protrude in the X-axis direction from the first sidewall part 121.

The protrusion 130 may be located in a groove G formed concavely in the Y-axis direction on the first sidewall part 121. For example, the sidewall part 420 of the coupling member 400 may be located on the first sidewall part 121, and a hook part 450 may be located on the sidewall part 420 (see FIG. 19). Considering the hook coupling using the protrusion 130 of the enclosure 100 and the hook part 450 of the coupling member 400 and the implementation of a compact sound apparatus 1, the protrusion 130 may be located in the groove G of the first sidewall part 121. For example, since the hook part 450 of the coupling member 400 is located in the groove G, a compact sound apparatus 1 may be implemented. The groove G of the first sidewall part 121 may be open in the Z-axis direction.

Referring to FIG. 2 together, the sound generation module 200 may output sound SO toward the indoor space IS of the vehicle 10.

Also, the sound generation module 200 may vibrate the interior material 13 of the vehicle 10 via the enclosure 100. Thereby, the sound generation module 200 may generate richer sound using the vibration of the interior material 13. For example, the sound generation module 200 may be configured to indirectly vibrate the interior material 13. For example, the sound generation module 200 may be configured to vibrate the interior material 13 by vibrating the enclosure 100. For example, the sound generation module 200 may be a sound generation unit, a sound generation member, a sound reproduction module, a sound reproduction unit, a car audio module, a car audio unit, a speaker module, or a speaker unit, but the implementations of the present specification are not limited thereto.

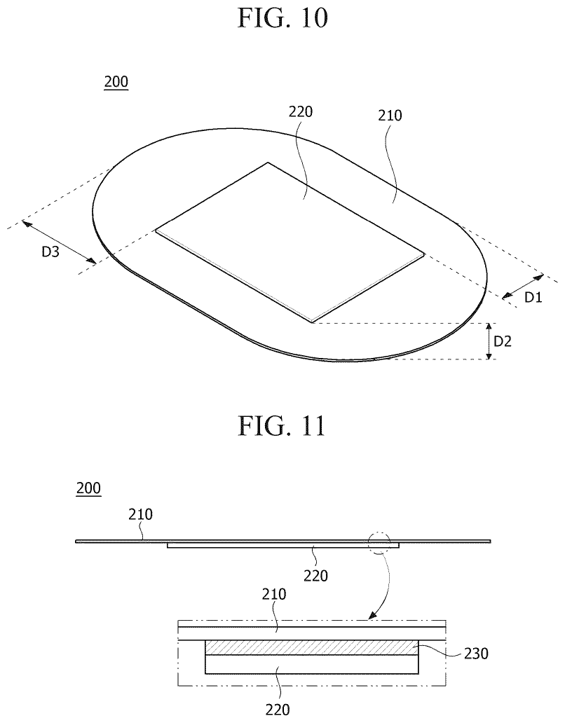

FIG. 10 is a rear perspective view illustrating a sound generation module of a sound apparatus according to an implementation of the present specification. FIG. 11 is a side view illustrating a sound generation module of a sound apparatus according to an implementation of the present specification.

The sound generation module 200 according to an implementation of the present specification may include a vibration member 210 and a vibration device 220.

The vibration device 220 according to an implementation of the present specification may be configured to vibrate the vibration member 210. For example, the vibration device may be located or configured on the vibration member 210. The vibration device 220 may be configured to vibrate (or displace or drive) the vibration member 210 by vibrating (or displacing or driving) according to an applied driving signal (or vibration driving signal or voice signal). The sound generation module 200 may include one or more vibration devices 220. For example, one or more vibration devices 220 may be located (or mounted) on the vibration member 210.

The vibration member 210 may generate vibration or output sound (or sound waves) according to the displacement (or driving) of the vibration device 220. For example, the vibration member 210 may be a plate, a vibration plate, a vibration substrate, a vibration object, a vibration panel, a sound plate, a sound panel, a passive vibration plate, a passive vibration member, a passive vibration panel, a sound output plate, or a sound vibration plate, and the implementations of the present specification are not limited thereto. For example, the vibration member 210 may include a metal material or one or more single non-metal or composite non-metal materials among wood, rubber, plastic, carbon, glass, fiber, cloth, paper, mirror, and leather, and the implementations of the present specification are not limited thereto. For example, paper may be cone paper for speakers. For example, cone paper may be pulp or foamed plastic, etc., and the implementations of the present specification are not limited thereto.

For example, the metal material of the vibration member 210 may include one or more materials among stainless steel, aluminum Al, aluminum Al alloy, magnesium Mg, magnesium Mg alloy, and magnesium lithium Mg—Li alloy, and the implementations of the present specification are not limited thereto. For example, the vibration member 210 may be composed of a metal material of aluminum material, or may be composed of a plastic material of plastic or styrene material, but the implementations of the present specification are not limited thereto. For example, the styrene material may be ABS material. The ABS material may be Acrylonitrile, Butadiene, and Styrene. For example, the vibration member 210 may be carbon fiber reinforced plastic CFRP, polypropylene, or polycarbonate, etc., and the implementations of the present specification are not limited thereto.

The vibration member 210 may include a first surface and a second surface different from (or opposite to) the first surface. The vibration device 220 may be located on the first surface (or rear surface or back surface) of the vibration member 210. The vibration member 210 may be formed in a shape including two curves spaced apart from each other and straight lines connecting the two curves, but is not necessarily limited thereto. For example, the vibration member 210 according to an implementation of the present specification may be formed in a track shape but is not limited thereto. For example, the vibration member 210 may also be formed in a shape such as a rectangle.

According to an implementation of the present specification, the vibration member 210 may include a shape of a rectangular structure including a curved surface, but the implementations of the present specification are not limited thereto. For example, the vibration member 210 may also have a rectangular shape with a long side and a short side. The vibration device 220 may have a shape corresponding to the vibration member 210 or the same shape as the vibration member 210, and the implementations of the present specification are not limited thereto. For example, the vibration device 220 may have the same shape as the vibration member 210, but the implementations of the present specification are not limited thereto. According to an implementation of the present specification, the vibration device 220 may have a rectangular shape.

According to an implementation of the present specification, the long side of the vibration device 220 may be parallel to the long side of the vibration member 210 and may be spaced apart from the long side of the vibration member 210 by a first distance D1. Here, the first distance D1 may be a first shortest distance between the long side of the vibration device 220 and the long side of the vibration member 210.

The short side of the vibration device 220 may be located facing the short side of the vibration member 210, and the short side of the vibration member 210 may be formed in an arc shape. The short side of the vibration device 220 may be spaced apart from the short side of the vibration member 210 formed in the arc shape by a second distance D2. Here, the second distance D2 may be the shortest distance between the short side of the vibration device 220 and the short side of the vibration member 210 formed in the arc shape.

The short side of the vibration device 220 may be spaced apart from the short side of the vibration member 210 formed in the arc shape by a third distance D3, which is the longest distance. Here, the third distance D3 may represent the longest distance between the short side of the vibration device 220 and the short side of the vibration member 210 formed in the arc shape.

The first distance D1 may be different from the second distance D2 and the third distance D3. For example, to minimize interference between vibrations generated in the vibration member 210, the first distance D1, the second distance D2, and the third distance D3 may be different, but are not necessarily limited thereto. For example, to minimize interference between vibrations generated in the region of the vibration member 210 included in the first distance D1, vibrations generated in the region of the vibration member 210 included in the second distance D2, and vibrations generated in the region of the vibration member 210 included in the third distance D3, the first distance D1, the second distance D2, and the third distance D3 may be different, but are not necessarily limited thereto. For example, the first distance D1 may be larger than the second distance D2, and the first distance D1 may be smaller than the third distance D3, but are not necessarily limited thereto. For example, the first distance D1 may be larger than the second distance D2, and the second distance D2 and the third distance D3 may be the same, but are not necessarily limited thereto. For example, since the displacement in the region of the vibration member 210 corresponding to each distance may be different according to the first distance D1, the second distance D2, and the third distance D3, each of the first distance D1, the second distance D2 and the third distance D3 may be individually adjusted considering the sound SO output to the indoor space IS. Thereby, the sound characteristics and/or sound pressure characteristics of the sound apparatus 1 may be improved.

The vibration device 220 may be configured to vibrate (or displace or drive) the vibration member 210 by vibrating (or displacing or driving) according to an applied driving signal (or vibration driving signal or voice signal). For example, the vibration device 220 may be a bimorph structure that vibrates (or displaces or drives) the vibration member 210 by vibrating (or displacing or driving) through a driving signal (or vibration driving signal or voice signal) applied to the vibration device 220, but the implementations of the present specification are not limited thereto.

The vibration device 220 may be configured on either the first surface or the second surface of the vibration member 210. For example, the vibration device 220 may be connected or configured on the first surface of the vibration member 210, but is not necessarily limited thereto.

The sound generation module 200 according to an implementation of the present specification may further include an adhesive member 230.

According to an implementation of the present specification, the adhesive member 230 may be located between the vibration member 210 and the vibration device 220. The vibration device 220 may be connected or coupled to the vibration member 210 by the adhesive member 230. For example, the vibration device 220 may be connected or coupled to the first surface of the vibration member 210 by the adhesive member 230.

The adhesive member 230 may include an adhesive layer (or adhesive layer) with excellent adhesion or adhesive force. For example, the adhesive member 230 may include adhesive, double-sided adhesive, double-sided tape, double-sided adhesive tape, double-sided adhesive foam tape, double-sided pad, double-sided foam pad, double-sided adhesive foam pad, double-sided cushion tape, or adhesive sheet, and the implementations of the present specification are not limited thereto.

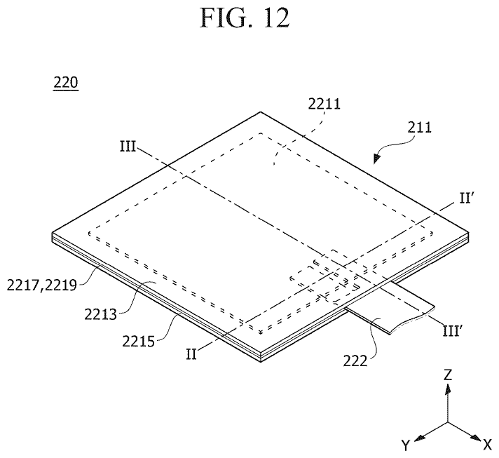

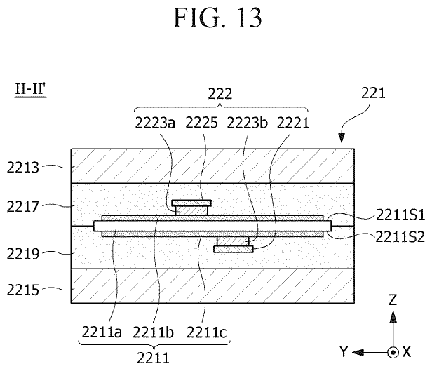

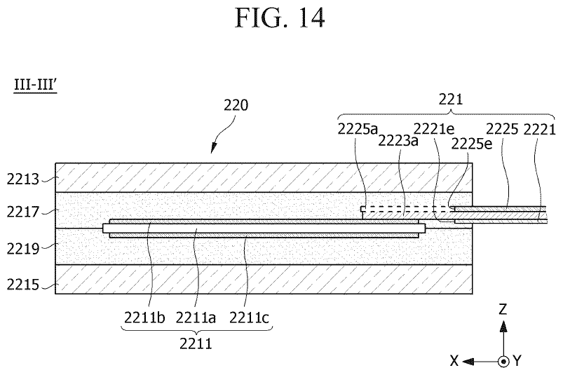

FIG. 12 is a diagram illustrating a vibration device according to an implementation of the present specification. FIG. 13 is a cross-sectional view along line II-II′ of FIG. 12 according to an implementation of the present specification. FIG. 14 is a cross-sectional view along line III-III′ of FIG. 12 according to an implementation of the present specification.

Referring to FIGS. 12 to 14, the sound generation module 200 according to an implementation of the present specification may include a vibration device 220. The vibration device 220 may include one or more vibration generators 221.

The vibration generator 221 may include a piezoelectric material having piezoelectric characteristics. The vibration generator 221 may vibrate (or displace or drive) the vibration member (or vehicle interior material) according to the vibration (or displacement or driving) of the piezoelectric material according to an electrical signal (or voice signal or sound signal) applied to the piezoelectric material. For example, the vibration generator 221 may vibrate (or displace or drive) by alternately repeating contraction and/or expansion due to the piezoelectric effect (or piezoelectric characteristics). For example, the vibration generator 221 may vibrate (or displace or drive) in the vertical direction or thickness direction Z-axis direction by alternately repeating contraction and/or expansion due to the inverse piezoelectric effect. For example, the vibration generator 221 may be vibrated or mechanically displaced (or vibrated or driven) in response to an electrical signal applied from the outside to the piezoelectric material including piezoelectric ceramics.

The vibration generator 221 may be composed of piezoelectric material of the ceramic family capable of relatively strong vibration implementation or piezoelectric ceramics having a crystal structure of the perovskite family. For example, the vibration generator 221 may be a vibration generation element, a vibration film, a vibration generation film, a vibrator, an active vibrator, an active vibration generator, an actuator, an exciter, a film actuator, a film exciter, an ultrasonic actuator, or an active vibration member, etc., and the implementations of the present specification are not limited thereto.

The vibration generator 221 according to an implementation of the present specification may include a vibration generation part 2211.

The vibration generation part 2211 may be configured to vibrate due to the piezoelectric effect according to a driving signal. For example, the vibration generation part 2211 may include a piezoelectric vibration part. The vibration generation part 2211 may include at least one of piezoelectric inorganic material and piezoelectric organic material. For example, the vibration generation part 2211 may be a vibration element, a piezoelectric element, a piezoelectric element part, a piezoelectric element layer, a piezoelectric structure, a piezoelectric vibration part, or a piezoelectric vibration layer, etc., and the implementations of the present specification are not limited thereto.

The vibration generation part 2211 according to an implementation of the present specification may include a vibration part 2211a, a first electrode part 2211b, and a second electrode part 2211c.

The vibration part 2211a may include a piezoelectric material or electroactive material including a piezoelectric effect. For example, the piezoelectric material may have a characteristic in which a potential difference is generated due to dielectric polarization according to the relative position change of positive ions and negative ions as pressure or twisting phenomena act on the crystal structure by external force, and conversely, vibration is generated by an electric field according to an applied voltage. For example, the vibration part 2211a may be a piezoelectric layer, a piezoelectric material layer, an electroactive layer, a piezoelectric composite layer, a piezoelectric composite, or a piezoelectric ceramic composite, etc., and the implementations of the present specification are not limited thereto.

The vibration part 2211a may be composed of a material of the ceramic family capable of relatively strong vibration implementation or piezoelectric ceramics having a crystal structure of the perovskite family. The perovskite crystal structure has piezoelectric and/or inverse piezoelectric effects and may be a plate-shaped structure with orientation. The perovskite crystal structure is expressed by the chemical formula ABO3, where the A site is composed of a divalent metal element, and the B site may be composed of a tetravalent metal element. As one implementation of the present specification, in the chemical formula ABO3, the A site and the B site may be cations, and O may be anions. For example, the vibration part 2211a may include at least one of PbTiO₃, PbZrO₃, PbZrTiO₃, BaTiO₃, and SrTiO₃, but the implementations of the present specification are not limited thereto.

Piezoelectric ceramics may be composed of a single crystal ceramic having a single crystal structure or a ceramic material having a polycrystalline structure or polycrystalline ceramics. The piezoelectric material of the single crystal ceramic may include α-AlPO₄, α-SiO₂, LiNbO₃, Tb₂ (MoO4)₃, Li2B₄O₇, or ZnO, but the implementations of the present specification are not limited thereto. The piezoelectric material of the polycrystalline ceramic may include PZT (lead zirconate titanate) material including lead Pb, zirconium Zr, and titanium Ti, or PZNN (lead zirconate nickel niobate) material including lead Pb, zirconium Zr, nickel Ni, and niobium Nb, but the implementations of the present specification are not limited thereto. For example, the vibration part 2211a may include at least one of CaTiO₃, BaTiO₃, and SrTiO₃ that do not include lead Pb, but the implementations of the present specification are not limited thereto.

The first electrode part 2211b may be located on the first surface (or upper surface or front surface) 2211s1 of the vibration part 2211a. The first electrode part 2211b may have the same size as the vibration part 2211a or a smaller size than the vibration part 2211a.

The second electrode part 2211c may be located on the second surface (or lower surface or back surface) 2211s2 of the vibration part 2211a that is different from or opposite to the first surface 2211s1. The second electrode part 2211c may have the same size as the vibration part 2211a or a smaller size than the vibration part 2211a. For example, the second electrode part 2211c may have the same shape as the vibration part 2211a, but the implementations of the present specification are not limited thereto.

According to an implementation of the present specification, to prevent electrical connection (or short) between the first electrode part 2211b and the second electrode part 2211c, each of the first electrode part 2211b and the second electrode part 2211c may be formed on the remainder of the portion excluding the edge portion of the vibration part 2211a. For example, the first electrode part 2211b may be formed on the entire remainder of the portion excluding the edge portion of the first surface 2211s1 of the vibration part 2211a. For example, the second electrode part 2211c may be formed on the entire remainder of the portion excluding the edge portion of the second surface 2211s2 of the vibration part 2211a. For example, the distance between the side (or outer wall) of each of the first electrode part 2211b and the second electrode part 2211c and the side (or outer wall) of the vibration part 2211a may be at least 0.5 mm or more. For example, the distance between the side of each of the first electrode part 2211b and the second electrode part 2211c and the side of the vibration part 2211a may be at least 1 mm or more, but the implementations of the present specification are not limited thereto.

According to an implementation of the present specification, one or more of the first electrode part 2211b and the second electrode part 2211c may be made of transparent conductive material, translucent conductive material, or opaque conductive material. For example, the transparent or translucent conductive material may include ITO (indium tin oxide) or IZO (indium zinc oxide), but the implementations of the present specification are not limited thereto. The opaque conductive material may include or may be made of an alloy of gold Au, silver Ag, platinum Pt, palladium Pd, molybdenum Mo, magnesium Mg, carbon, or silver Ag containing glass frit, etc., but the implementations of the present specification are not limited thereto. For example, each of the first electrode part 2211b and the second electrode part 2211c may include silver Ag with low resistivity to improve the electrical characteristics and/or vibration characteristics of the vibration part 2211a. For example, carbon may be a carbon material including carbon black, ketjen black, carbon nanotubes, and graphite, but the implementations of the present specification are not limited thereto.

The vibration part 2211a may be polarized (or poled) by a constant voltage applied to the first electrode part 2211b and the second electrode part 2211c in a constant temperature atmosphere or a temperature atmosphere changing from high temperature to room temperature, but the implementations of the present specification are not limited thereto. For example, the polarization direction (or poling direction) formed in the vibration part 2211a may be formed or oriented (or located) from the first electrode part 2211b to the second electrode part 2211c, but is not limited thereto. For example, the polarization direction (or poling direction) formed in the vibration part 2211a may be formed or oriented (or located) from the second electrode part 2211c to the first electrode part 2211b.

The vibration part 2211a may vibrate by alternately repeating contraction and/or expansion due to the inverse piezoelectric effect according to a driving signal applied to the first electrode part 2211b and the second electrode part 2211c from the outside. For example, the vibration part 2211a may vibrate in the vertical direction (or thickness direction) and the planar direction by a signal applied to the first electrode part 2211b and the second electrode part 2211c. The vibration part 2211a may improve the vibration characteristics including sound characteristics and/or sound pressure characteristics of the vibration generator 221 by being displaced (or vibrated) or driven by contraction and/or expansion in the planar direction.

The vibration generator 221 according to an implementation of the present specification may further include a first cover member 2213 and a second cover member 2215.

The first cover member 2213 may be located on the first surface of the vibration generation part 2211. For example, the first cover member 2213 may be configured to cover the first electrode part 2211b of the vibration generation part 2211. For example, the first cover member 2213 may be on the first electrode part 2211b. For example, the first cover member 2213 may be configured to have a size larger than the vibration generation part 2211. The first cover member 2213 may be configured to protect the first surface of the vibration generation part 2211 and the first electrode part 2211b.

The second cover member 2215 may be located on the second surface of the vibration generation part 2211. For example, the second cover member 2215 may be configured to cover the second electrode part 2211c of the vibration generation part 2211. For example, the second cover member 2215 may be on the second electrode part 2211c. For example, the second cover member 2215 may be configured to have a size larger than the vibration generation part 2211, and may be configured to have the same size as the first cover member 2213. The second cover member 2215 may be configured to protect the second surface of the vibration generation part 2211 and the second electrode part 2211c.

The first cover member 2213 and the second cover member 2215 according to an implementation of the present specification may include the same or different materials. For example, each of the first cover member 2213 and the second cover member 2215 may be a polyimide film, a polyethylene terephthalate film, or a polyethylene naphthalate film, etc., but the implementations of the present specification are not limited thereto.

The first cover member 2213 may be connected or coupled to the first surface of the vibration generation part 2211 or the first electrode part 2211b via a first adhesive layer 2217. For example, the first cover member 2213 may be connected or coupled to the first surface of the vibration generation part 2211 or the first electrode part 2211b by a film laminating process via the first adhesive layer 2217.

The second cover member 2215 may be connected or coupled to the second surface of the vibration generation part 2211 or the second electrode part 2211c via a second adhesive layer 2219. For example, the second cover member 2215 may be connected or coupled to the second surface of the vibration generation part 2211 Tor the second electrode part 2211c by a film laminating process via the second adhesive layer 2219.

Each of the first adhesive layer 2217 and the second adhesive layer 2219 according to an implementation of the present specification may include an electrically insulating material that has adhesiveness and is capable of compression and restoration. For example, each of the first adhesive layer 2217 and the second adhesive layer 2219 may include epoxy resin, acrylic resin, silicone resin, urethane resin, acrylic family polymer, silicone family polymer, or urethane family polymer, etc., but the implementations of the present specification are not limited thereto.

The first adhesive layer 2217 and the second adhesive layer 2219 may be configured between the first cover member 2213 and the second cover member 2215 to surround the vibration generation part 2211. For example, one or more of the first adhesive layer 2217 and the second adhesive layer 2219 may be configured to partially or completely surround the vibration generation part 2211.

Either one of the first cover member 2213 and the second cover member 2215 may be connected or coupled to the vibration member 210 via the adhesive member 230.

The vibration generator 221 according to an implementation of the present specification may further include a signal supply member 222.

The signal supply member 222 may be configured to supply a driving signal supplied from a driving circuit part to the vibration generation part 2211. The signal supply member 222 may be configured to be electrically connected to the vibration part 2211a. The signal supply member 222 may be configured to be electrically connected to the first electrode part 2211b and the second electrode part 2211c of the vibration part 2211a.

A part of the signal supply member 222 may be accommodated (or inserted) between the first cover member 2213 and the second cover member 2215. The end part (or terminal part or one side) of the signal supply member 222 may be located or inserted (or accommodated) in the part between the one side edge portion of the first cover member 2213 and the one side edge portion of the second cover member 2215. The one side edge portion of the first cover member 2213 and the one side edge portion of the second cover member 2215 may accommodate or cover the end part (or terminal part or one side) of the signal supply member 222 up and down. Thereby, the signal supply member 222 may be integrated with the vibration generation part 2211. Therefore, the sound generation module 200 or the vibration device 220 may be implemented in a film form integrated with the signal supply member 222. For example, the signal supply member 222 may be configured as one part with the vibration generation part 2211, and thereby there is an effect of uni-materialization. For example, the signal supply member 222 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but the implementations of the present specification are not limited thereto.

The signal supply member 222 according to an implementation of the present specification may include a base member 2221, and a plurality of signal lines 2223a, 2223b. For example, the signal supply member 222 may include a base member 2221, a first signal line 2223a, and a second signal line 2223b.

The base member 2221 may include transparent or opaque plastic material, but the implementations of the present specification are not limited thereto. The base member 2221 may have a constant width along a first direction (Y-axis direction) and may extend long along a second direction (X-axis direction) that intersects with the first direction (Y-axis direction).

The first signal line 2223a and the second signal line 2223b may be located on the first surface of the base member 2221 to be parallel to the second direction (X-axis direction), and may be spaced apart or electrically separated from each other along the first direction (Y-axis direction). The first signal line 2223a and the second signal line 2223b may be located parallel to each other on the first surface of the base member 2221. For example, the first signal line 2223a and the second signal line 2223b may be implemented in a line shape by patterning a metal layer (or conductive layer) formed or deposited on the first surface of the base member 2221.

The end parts (or terminal parts or one sides) of the first signal line 2223a and the second signal line 2223b may be separated from each other so that they may be bent or bended individually.

The end part (or terminal part or one side) of the first signal line 2223a may be electrically connected to the first electrode part 2211b of the vibration generation part 2211. For example, the end part of the first signal line 2223a may be electrically connected to at least a part of the first electrode part 2211b of the vibration generation part 2211 at the one side edge portion of the first cover member 2213. For example, the end part (or terminal part or one side) of the first signal line 2223a may be directly electrically connected to at least a part of the first electrode part 2211b of the vibration generation part 2211. For example, the end part (or terminal part or one side) of the first signal line 2223a may be directly connected or directly contacted with the first electrode part 2211b of the vibration generation part 2211. For example, the end part of the first signal line 2223a may be electrically connected to the first electrode part 2211b through a conductive double-sided tape. Accordingly, the first signal line 2223a may supply a first driving signal supplied from the vibration driving part to the first electrode part 2211b of the vibration generation part 2211.

The end part (or terminal part or one side) of the second signal line 2223b may be electrically connected to the second electrode part 2211c of the vibration generation part 2211. For example, the end part of the second signal line 2223b may be electrically connected to at least a part of the second electrode part 2211c of the vibration generation part 2211 at the one side edge portion of the second cover member 2215. For example, the end part of the second signal line 2223b may be directly electrically connected to at least a part of the second electrode part 2211c of the vibration generation part 2211. For example, the end part of the second signal line 2223b may be directly connected or directly contacted with the second electrode part 2211c of the vibration generation part 2211. For example, the end part of the second signal line 2223b may be electrically connected to the second electrode part 2211c through a conductive double-sided tape. Accordingly, the second signal line 2223b may supply a second driving signal supplied from the vibration driving part to the second electrode part 2211c of the vibration generation part 2211.

The signal supply member 222 according to an implementation of the present specification may further include an insulating layer 2225.

The insulating layer 2225 may be located on the first surface of the base member 2221 to cover each of the first signal line 2223a and the second signal line 2223b except for the end part (or one side) of the signal supply member 222.

The end part (or one side) of the signal supply member 222 including the end part (or one side) of the base member 2221 and the end part (or one side) 2225a of the insulating layer 2225 may be inserted (or accommodated) between the first cover member 2213 and the second cover member 2215, and may be fixed between the first cover member 2213 and the second cover member 2215 by the first adhesive layer 2217 and the second adhesive layer 2219. Thereby, the end part (or one side) of the first signal line 2223a is maintained in a state of being electrically connected to the first electrode part 2211b of the vibration generation part 2211, and the end part (or one side) of the second signal line 2223b is maintained in a state of being electrically connected to the second electrode part 2211c of the vibration generation part 2211. Also, since the end part (or one side) of the signal supply member 222 is inserted (or accommodated) and fixed between the vibration generation part 2211 and the first cover member 2213, connection failure between the vibration generation part 2211 and the signal supply member 222 due to the movement of the signal supply member 222 may be prevented.

In the signal supply member 222 according to an implementation of the present specification, the end part (or one side) of the base member 2221 and the end part (or one side) 2225a of the insulating layer 2225 may each be removed. For example, the end part (or one side) of the first signal line 2223a and the end part (or one side) of the second signal line 2223b may not be supported by or covered by the end part (or one side) of the base member 2221 and the end part (or one side) 2225a of the insulating layer 2225, and may be exposed to the outside. For example, the end parts (or one sides) of the first signal line 2223a and the second signal line 2223b may protrude or extend by a certain length from the end 2221e of the base member 2221 or the end 2225e of the insulating layer 2225. Thereby, the end parts (or terminal parts or one sides) of the first signal line 2223a and the second signal line 2223b may be bent individually or independently.

The end part (or one side) of the first signal line 2223a, which is not supported by the end part (or one side) of the base member 2221 and the end part (or one side) 2225a of the insulating layer 2225, may be directly connected or directly contacted with the first electrode part 2211b of the vibration generation part 2211. The end part (or one side) of the second signal line 2223b, which is not supported by the end part (or one side) of the base member 2221 and the end part (or one side) 2225a of the insulating layer 2225, may be directly connected or directly contacted with the second electrode part 2211c of the vibration generation part 2211.

According to an implementation of the present specification, the signal supply member 222 may be integrated with the vibration generation part 2211 by having a portion of the signal supply member 222 or a portion of the base member 2221 located or inserted (or accommodated) between the first cover member 2213 and the second cover member 2215. Thereby, the vibration generation part 2211 and the signal supply member 222 may be configured as one part, resulting in the effect of uni materialization.

According to an implementation of the present specification, since the first signal line 2223a and the second signal line 2223b of the signal supply member 222 are integrated with the vibration generation part 2211, a soldering process for electrical connection between the vibration generation part 2211 and the signal supply member 222 is not required, so the structure and manufacturing process of the vibration device 220 may be simplified, and thereby, there is an effect of improving harmful processes.

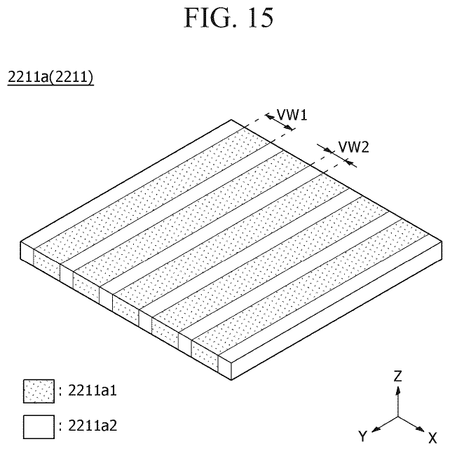

FIG. 15 is a diagram illustrating a vibration part according to another implementation of the present specification. FIG. 15 illustrates another implementation of the vibration part described with reference to FIGS. 12 to 14.

Referring to FIGS. 13 and 15, the vibration part 2211a according to another implementation of the present specification may include a plurality of first portions 2211a1 and a plurality of second portions 2211a2. For example, the plurality of first portions 2211a1 and the plurality of second portions 2211a2 may be located alternately and repeatedly along the second direction (X-axis direction) (or the first direction (Y-axis direction)).

Each of the plurality of first portions 2211a1 may include an inorganic material having a piezoelectric effect (or piezoelectric characteristic). For example, each of the plurality of first portions 2211a1 may include at least one of piezoelectric inorganic material and piezoelectric organic material. For example, each of the plurality of first portions 2211a1 may be an inorganic part, an inorganic material part, a piezoelectric part, a piezoelectric material part, or an electroactive part, and the implementations of the present specification are not limited thereto.

According to an implementation of the present specification, each of the plurality of first portions 2211a1 may have a first width VW1 parallel to the second direction (X-axis direction) (or the first direction (Y-axis direction)), and may extend along the first direction (Y-axis direction) (or the second direction (X-axis direction)). Each of the plurality of first portions 2211a1 is substantially the same as the vibration part 2211a described with reference to FIGS. 12 to 14, so a duplicate explanation of this may be omitted or simplified.

Each of the plurality of second portions 2211a2 may be located between the plurality of first portions 2211a1. For example, each of the plurality of first portions 2211a1 may be located between two adjacent second portions 2211a2 of the plurality of second portions 2211a2. Each of the plurality of second portions 2211a2 may have a second width VW2 parallel to the second direction (X-axis direction) (or the first direction (Y-axis direction)), and may extend along the first direction (Y-axis direction) (or the second direction (X-axis direction)). The first width VW1 may be the same as or different from the second width VW2. For example, the first width VW1 may be larger than the second width VW2. For example, the first portion 2211a1 and the second portion 2211a2 may include line shapes or stripe shapes of the same or different sizes.

Each of the plurality of second portions 2211a2 may be configured to fill the gap between two adjacent first portions 2211a1. Each of the plurality of second portions 2211a2 may be connected or adhered to the sides of adjacent first portions 2211a1 by being configured to fill the gap between two adjacent first portions 2211a1. According to an implementation of the present specification, each of the plurality of first portions 2211a1 and the plurality of second portions 2211a2 may be located (or arranged) parallel to each other on the same plane (or same layer). Accordingly, the vibration part 2211a may be expanded to a desired size or length by the side coupling (or connection) of the first portion 2211a1 and the second portion 2211a2.

According to an implementation of the present specification, each of the plurality of second portions 2211a2 may improve the durability of the first portion 2211a1 by absorbing the impact applied to the first portion 2211a1, and may provide flexibility to the vibration part 2211a. Each of the plurality of second portions 2211a2 may include an organic material having a flexible characteristic. For example, the plurality of second portions 2211a2 may be one or more of epoxy family polymer, acrylic family polymer, and silicone family polymer, and the implementations of the present specification are not limited thereto. For example, each of the plurality of second portions 2211a2 may be an organic part, an organic material part, an adhesive part, an expansion part, a bending part, a damping part, or a flexible part, and the implementations of the present specification are not limited thereto.

The first surface of each of the plurality of first portions 2211a1 and the plurality of second portions 2211a2 may be commonly connected to the first electrode part 2211b. The second surface of each of the plurality of first portions 2211a1 and the plurality of second portions 2211a2 may be commonly connected to the second electrode part 2211c. For example, one or both of the first electrode part 2211b and the second electrode part 2211c may be formed as a patterned electrode to correspond only to the plurality of first portions 2211a1.

The vibration part 2211a according to another implementation of the present specification may have a single thin film shape by having the plurality of first portions 2211a1 and the second portion 2211a2 located (or connected) on the same plane. Thereby, the vibration generation part 2211 or vibration generator 221 including the vibration part 2211a according to another implementation of the present specification may vibrate due to the first portion 2211a1 having vibration characteristics, and may be bent into a curved shape due to the second portion 2211a2 having flexibility.

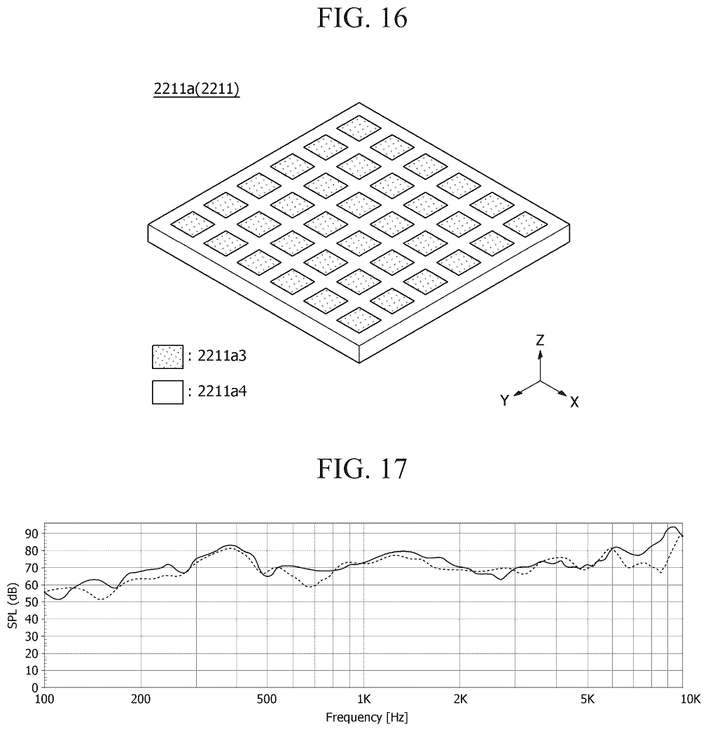

FIG. 16 is a diagram illustrating a vibration part according to another implementation of the present specification. FIG. 16 illustrates another implementation of the vibration part described with reference to FIGS. 12 to 14.

Referring to FIGS. 13 and 16, the vibration generation part 2211 according to another implementation of the present specification may include a plurality of first portions 2211a3, and a second portion 2211a4 located between the plurality of first portions 2211a3.

Each of the plurality of first portions 2211a3 may be located to be spaced apart from each other along the first direction (Y-axis direction) and the second direction (X-axis direction). For example, each of the plurality of first portions 2211a3 may be located in a grid shape while having a hexahedral shape of the same size, but the implementations of the present specification are not limited thereto. For example, each of the plurality of first portions 2211a3 may have a circular plate, an oval plate, or a polygonal plate shape of the same size, and the implementations of the present specification are not limited thereto.

Each of the plurality of first portions 2211a3 is substantially the same as the first portion 2211a1 described in FIG. 15, and a duplicate explanation of this may be omitted or simplified.

The second portion 2211a4 may be located between the plurality of first portions 2211a3 along the first direction (Y-axis direction) and the second direction (X-axis direction). The second portion 2211a4 may be connected or adhered to the adjacent first portion 2211a3 by filling the gap between two adjacent first portions 2211a3 or being adjacent to each of the plurality of first portions 2211a3 or surrounding each of the plurality of first portions 2211a3. The second portion 2211a4 is substantially the same as the second portion 2211a2 described in FIG. 15, and a duplicate explanation of this may be omitted or simplified.

The first surface of each of the plurality of first portions 2211a3 and the second portion 2211a4 may be commonly connected to the first electrode part 2211b. The second surface of each of the plurality of first portions 2211a3 and the second portion 2211a4 may be commonly connected to the second electrode part 2211c. In another example, one or both of the first electrode part 2211b and the second electrode part 2211c may be formed as a patterned electrode to correspond only to the plurality of first portions 2211a3.

The vibration part 1311a according to another implementation of the present specification may have a single thin film shape by having the plurality of first portions 2211a3 and the second portion 2211a4 located (or connected) on the same plane. Thereby, the vibration generation part 2211 or vibration generator 221 including the vibration part 2211a according to another implementation of the present specification may vibrate due to the first portion 2211a3 having vibration characteristics, and may be bent into a curved shape due to the second portion 2211a4 having flexibility.

FIG. 17 is a graph illustrating sound pressure characteristics according to the material of a supporting member of a sound apparatus according to an implementation of the present specification. In FIG. 17, the horizontal axis represents frequency (Hz), and the vertical axis represents sound pressure level (SPL, dB). The sound output characteristics were measured in a half anechoic room. During measurement, the input voltage was 10V, and the applied frequency signal was performed as a sine sweep from 100 Hz to 10 kHz. The distance between the sound apparatus 1 and the microphone was 1m. The measurement method is not limited to this example.

The solid line in FIG. 17 shows the result measured in a sound apparatus including a supporting member 300 having property A, and the dotted line shows the result measured in a sound apparatus including a supporting member 300 having property B. It may be seen that the sound pressure characteristics measured in the sound apparatus 1 each including a supporting member 300 having different properties are different from each other. For example, the supporting member 300 represented by the solid line may be formed of foam rubber material, and the supporting member 300 represented by the dotted line may be formed of polyolefin. Here, the hardness of the supporting member 300 formed of polyolefin material may be relatively harder than the hardness of the supporting member 300 formed of foam rubber material.

Referring to FIG. 17, it may be confirmed that the supporting member 300 having property B has a relatively larger dip of sound pressure in the reproduction band of 150 Hz and the reproduction band of 700 Hz compared to the supporting member 300 having property A. Therefore, the supporting member 300 having property A may implement softer sound compared to the supporting member 300 having property B. For example, the maximum sound pressure and the minimum sound pressure generated in the reproduction frequency band of the sound generated according to the vibration of the supporting member 300 may each decrease, and thereby the flatness of the sound pressure may be further improved. Here, the dip may be a phenomenon where the sound pressure drops sharply at a specific frequency on the graph.

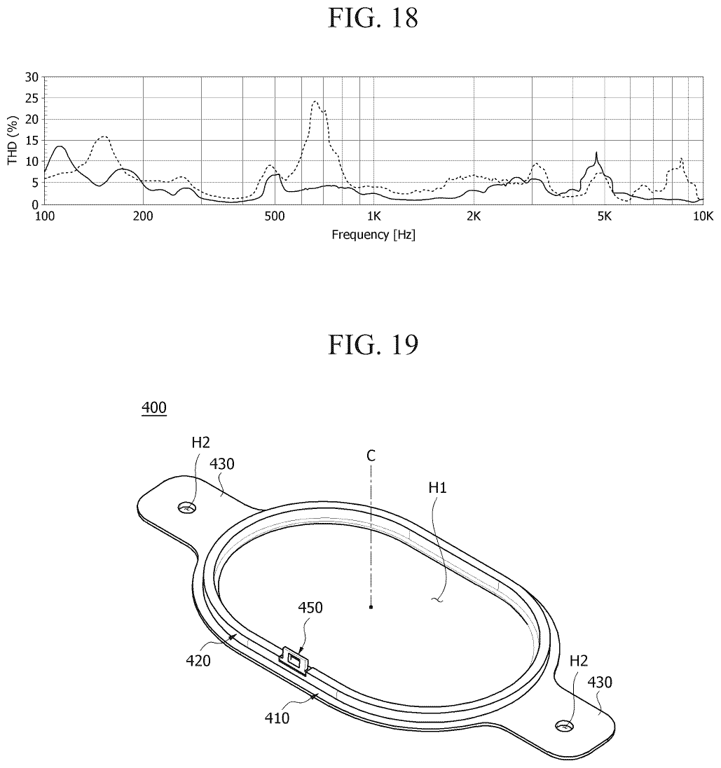

FIG. 18 is a graph illustrating total harmonic distortion characteristics according to the material of a supporting member of a sound apparatus according to an implementation of the present specification. In FIG. 18, the horizontal axis represents frequency (Hz (hertz)), and the vertical axis represents total harmonic distortion Total Harmonic Distortion; THD ratio (%). The solid line in FIG. 18 shows the result measured in a sound apparatus including a supporting member 300 having property A, and the dotted line shows the result measured in a sound apparatus 1 including a supporting member 300 having property B. It may be seen that the total harmonic distortion characteristics measured in the sound apparatus 1 each including a supporting member 300 having different properties are different from each other. For example, the supporting member 300 represented by the solid line may be formed of foam rubber material, and the supporting member 300 represented by the dotted line may be formed of polyolefin.

Referring to FIG. 18, the supporting member 300 having property A may have a total harmonic distortion ratio of about 4% in the reproduction band of 650 Hz. Also, the supporting member 300 having property B may have a total harmonic distortion ratio of about 24% in the reproduction band of 650 Hz. Accordingly, the supporting member 300 having property A does not have a frequency band that rises sharply compared to the supporting member 300 having property B, and it may output high-quality sound with improved sound pressure characteristics and sound quality.

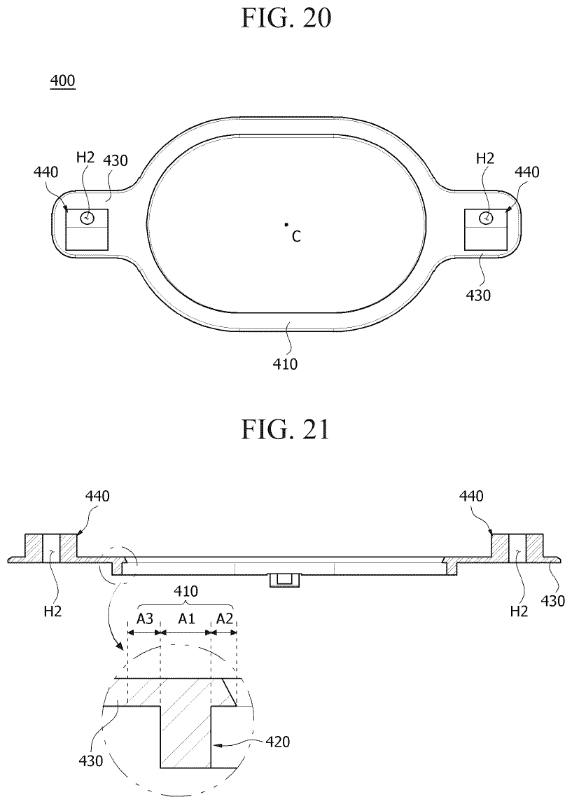

FIG. 19 is a rear perspective view illustrating a coupling member of a sound apparatus according to an implementation of the present specification. FIG. 20 is a plan view illustrating a coupling member of a sound apparatus according to an implementation of the present specification. FIG. 21 is a cross-sectional view illustrating a coupling member of a sound apparatus according to an implementation of the present specification.

Referring to FIGS. 19 and 20, the coupling member 400 may include at least one first hole H1.

The first hole H1 may be configured to penetrate the coupling member 400 in the Z-axis direction. For example, the first hole H1 may be formed to penetrate the coupling member 400 in the thickness direction of the coupling member 400. For example, the first hole H1 may be formed to vertically penetrate the coupling member 400 in the thickness direction of the coupling member 400. For example, the first hole H1 of the coupling member 400 may be a sound emission part, a sound emission hole, a sound output part, a sound output hole, a sound output hole, or a vent hole, and the implementations of the present specification are not limited thereto.

The first hole H1 may be a space where sound waves generated by the vibration of the sound generation module 200 are propagated (or transmitted) to the indoor space IS of the vehicle 10. For example, the vibration of the sound generation module 200 may be transmitted to the indoor space IS of the vehicle 10 through the first hole H1. For example, the sound wave (or sound) according to the vibration of the sound generation module 200 may be transmitted (or output or emitted) to the indoor space IS of the vehicle 10 through the first hole H1. Thereby, the vibration amplitude (or displacement amplitude) of the vibration member 210 according to the vibration of the sound generation module 200 may increase, and the sound characteristics and/or sound pressure characteristics generated according to the vibration of the vibration member 210 may be improved.

Referring to FIGS. 19 to 21, the coupling member 400 may include a body part 410 and a sidewall part 420.

The body part 410 may include the first hole H1. The sidewall part 420 may protrude toward the enclosure 100. For example, the sidewall part 420 may protrude in the Z-axis direction from the body part 410.

The coupling member 400 may further include an extension part 430 extending from the body part 410. The coupling member 400 may further include a protrusion part 440 protruding from the extension part 430. The coupling member 400 may further include a hook part 450 coupled to the protrusion 130 of the enclosure 100. The body part 410, the sidewall part 420, the extension part 430, the protrusion part 440, and the hook part 450 may be integrally configured, but the implementations of the present specification are not limited thereto.

The body part 410 and the sidewall part 420 may be integrally configured, but the implementations of the present specification are not limited thereto. When coupling the sound apparatus 1 to the interior material 13, the body part 410 and the sidewall part 420 may contact (or couple or connect) with the interior material 13. Also, the edge of the vibration member 210 may be coupled (or connected) to the body part 410. For example, the edge of the vibration member 210 may be coupled (or connected) to the body part 410 using an adhesive member. As a result, the vibration transmitted from the vibration member 210 to the body part 410 may be transmitted to the interior material 13 without loss of vibration, and the coupling with the enclosure 100 may also be firmly made. For example, since the body part 410 and the sidewall part 420 are integrally configured, the vibration of the body part 410 may be transmitted to the interior material 13 through the sidewall part 420 without loss of vibration. For example, since the body part 410 and the sidewall part 420 are integrally configured, even if a certain pressure or load is applied to the coupling member 400, the body part 410 and the sidewall part 420 are not separated, and accordingly, the coupling between the enclosure sidewall 120 and the sidewall part 420 may be firmly made.

The body part 410 may be configured in a plate shape with the first hole H1 formed in the center. Accordingly, the body part 410 may be configured in a ring shape, but is not necessarily limited thereto.

The first surface (or back surface, rear surface or lower surface) of the body part 410 may overlap with the vibration member 210, and the first surface (or back surface, rear surface or lower surface) of the body part 410 and the vibration member 210 may be coupled (or connected) using an adhesive member. The vibration member 210 may be located between the body part 410 and the supporting member 300, and the vibration generated by the vibration device 220 may be transmitted to the body part 410 and the supporting member 300 through the vibration member 210.

Based on the sidewall part 420 protruding from the body part 410, the body part 410 may include a central region A1 overlapping with the sidewall part, and an inner region A2 located on the inner side of the central region A1. Also, the body part 410 may further include an outer region A3 located on the outer side of the central region A1. The inner region A2 may overlap with the edge of the vibration member 210, and the outer region A3 may overlap with the interior material 13. For example, the body part 410 may include only the central region A1 and the inner region A2, or may include the central region A1, the inner region A2, and the outer region A3. For example, if the body part 410 is formed only with the central region A1 and the inner region A2, the extension part 430 extends in the horizontal direction from a part of the central region A1, and overlaps with the interior material 13, so vibration may be transmitted to the interior material 13 only through the extension part 430. If the body part 410 is formed with the central region A1, the inner region A2, and the outer region A3, it may transmit more uniform vibration to the interior material 13 than when the body part 410 is formed only with the central region A1 and the inner region A2.

The central region A1 may be located between the inner region A2 and the outer region A3 based on the horizontal direction. Also, the sidewall part 420 may extend from the central region A1.

The inner region A2 is located on the inner side of the central region A1, and may overlap with the edge of the vibration member 210. Accordingly, when coupling the enclosure 100 and the coupling member 400, the inner region A2 may apply a certain pressure or load to the coupling member 400. Also, the inner region A2 may be coupled (or connected) with the edge of the vibration member 210. Also, the end of the inner region A2 may form the first hole H1.

The outer region A3 is located on the outer side of the central region A1, and may be configured to surround the central region A1. Also, the outer region A3 may overlap with the interior material 13. Also, the outer region A3 may contact, couple, or connect with the interior material 13. Accordingly, vibration transmitted to the outer region A3 through the inner region A2 and the central region A1 may be transmitted to the interior material 13.

The sidewall part 420 may extend protruding from the body part 410. For example, the sidewall part 420 may be formed to protrude in the Z-axis direction from the central region A1 of the body part 410, and may be located toward the enclosure 100.

The sound apparatus 1 according to an implementation of the present specification may be located between the roof panel as the exterior material 12 of the vehicle 10 and the headliner as the interior material 13 or may be located to be exposed to the space between the exterior material 12 and the interior material 13, so moisture and/or impurities, etc. entering the space between the exterior material 12 and the interior material 13 may flow into the inside of the sound apparatus 1 or toward the indoor space IS.

The sidewall part 420 may be located on the outside of the second sidewall part 122 of the enclosure sidewall 120 to primarily block moisture and impurities, etc. from entering the internal space S of the enclosure 100. Also, the sidewall part 420 may be located in a hole formed in the interior material 13 and coupled (or connected) with the interior material 13 to primarily block moisture and impurities, etc. from entering toward the indoor space IS. Since the interior material 13 may contact, couple, or connect with the outer region A3 of the coupling member 400, it may secondarily block moisture and/or impurities, etc. from entering toward the indoor space IS. Also, since the outer region A3 extends protruding from the central region A1, it may further prevent moisture and/or impurities, etc. from entering the indoor space IS by increasing the length of the path through which moisture and/or impurities, etc. enter the indoor space IS.

The extension part 430 may extend protruding in the horizontal direction from the body part 410. For example, the extension part 430 may extend from the outer region A3 of the body part 410. For example, the extension part 430 may also extend from the central region A1 of the body part 410.

For uniform coupling of the coupling member 400 and the interior material 13 using the fastening member 600, the coupling member 400 may include at least two extension parts 430. The at least two extension parts 430 may be located in rotational symmetry based on the center C.

The extension part 430 may include a second hole H2 through which the fastening member 600 penetrates.

The second hole H2 may be configured to penetrate the extension part 430 in the axial direction. For example, the second hole H2 may be formed to penetrate the extension part 430 in the thickness direction of the extension part 430. For example, the second hole H2 may be formed to vertically penetrate the extension part 430 in the thickness direction of the extension part 430. For example, since the protrusion part 440 may be located on the extension part 430, the second hole H2 located on the extension part 430 may extend in the Z-axis direction to penetrate the protrusion part 440. For example, the second hole H2 of the extension part 430 may be a fastening hole or a penetration hole, and the implementations of the present specification are not limited thereto.

The protrusion part 440 may protrude from the extension part 430. For example, the protrusion part 440 may protrude in the Z-axis direction from the extension part 430. For example, the protrusion part 440 may protrude vertically from the extension part 430. For example, the protrusion part 440 may protrude from the extension part 430 toward the indoor space IS of the vehicle 10.

A hole may be formed inside the protrusion part 440 in the protrusion direction of the protrusion part 440. The hole may extend the second hole H2. Accordingly, the fastening member 400 may penetrate the extension part 430 and the protrusion part 440 through the second hole H2.

The protrusion part 440 may be provided for a fixing member (e.g., handle) 500 that is rotatably located on the coupling member 400, but is not necessarily limited thereto. For example, the coupling member 400 may be provided without the protrusion part 440 being omitted from the coupling member 400, and a groove or hole may be formed in the extension part 430 where the end of the handle 500 may be located. Accordingly, the handle 500 may couple with the extension part 430 of the coupling member 400 from which the protrusion part 440 is omitted.

The hook part 450 may improve the coupling force between the enclosure 100 and the coupling member 400 by coupling with the protrusion 130 of the enclosure 100. As the hook part 450 is guided by the groove G formed in the first sidewall part 121, the coupling member 400 may be located at a preset position.

The hook part 450 may be a protrusion, groove, hole, etc. corresponding to the protrusion 130 of the enclosure 100, but the implementations of the present specification are not limited thereto. For example, the hook part 450 may be provided in a shape of a plate-shaped member with a hole formed therein. For example, the hook part 450 may be provided in a shape of a plate-shaped member with a hole formed therein that protrudes in the Z-axis direction from the sidewall part 420, but is not necessarily limited thereto. For example, the hook part 450 may be a hook that couples by catching on the protrusion 130 of the enclosure 100. Accordingly, the hook part 450 may couple with the protrusion 130 of the enclosure 100 in a hook manner.

The fixing member (e.g., handle) 500 may couple with the coupling member 400. Accordingly, transportation of the sound apparatus 1 may be easily carried out through the handle 500, and installation work or maintenance work of the sound apparatus 1 may also be easily performed using the handle 500.

The handle 500 may be rotatably coupled to the coupling member 400. For example, the handle 500 may be rotatably located on the protrusion part 440 of the coupling member 400. The handle 500 may be rotatably located on the protrusion part 440 of the coupling member 400 through the shaft 510.

The handle 500 may be formed in a gantry type, but is not necessarily limited thereto. For example, the handle 500 may be configured in various shapes such as an arc shape, a hemispherical shape, a hook shape, etc.

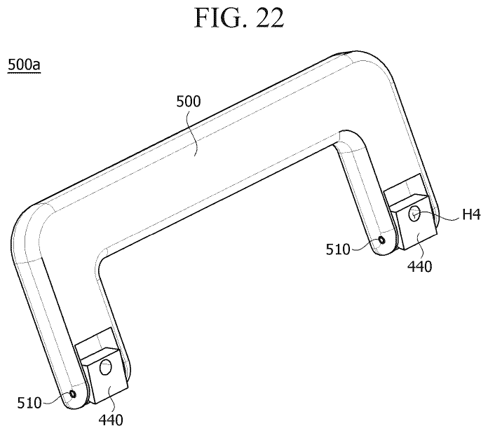

FIG. 22 is a diagram illustrating another implementation of a fixing member of a sound apparatus according to an implementation of the present specification.

Referring to FIG. 22, the sound apparatus 1 may include a handle module 500a.

The handle module 500a may include a fixing member or handle 500, a shaft 510, and a protrusion part 440. Accordingly, the protrusion part 440 located on the coupling member 400 may be omitted from the coupling member 400. For example, the coupling member 400 may include a body part 410 including a first hole H1, a sidewall part 420, and an extension part 430 extending from the body part 410. For example, the handle module 500a may be a fixing module, etc., but the implementations of the present specification are not limited thereto.

The handle module 500a may include a handle 500, a shaft 510, and a protrusion part 440. The protrusion part 440 may be rotatably located on the handle 500 via the shaft 510. The handle module 500a may be coupled to the coupling member 400 by a fastening member 600 penetrating the fourth hole H4 formed in the protrusion part 440 penetrating the second hole H2 of the extension part 430.

The fastening member 600 may strengthen the coupling between the sound apparatus 1 and the interior material 13. For example, the fastening member 600 may firmly couple the sound apparatus 1 to the interior material 13 by penetrating the interior material 13 and the coupling member 400. For example, the fastening member 600 may include a bolt, a bolt and a nut, a bolt, a washer and a nut, a screw, etc., but the implementations of the present specification are not limited thereto.

The sound apparatus 1 according to an implementation of the present specification may further include a bracket 700.

The bracket 700 may be located facing the first surface (or back surface, rear surface or lower surface) of the interior material 13. The bracket 700 may couple with the end of the fastening member 600 that has penetrated the interior material 13 and the coupling member 400. A part of the interior material 13 may be located between the coupling member 400 and the bracket 700, and the coupling member 400 and the bracket 700 may be adhered to the interior material 13 by the fastening force of the fastening member 600. Accordingly, the sound apparatus 1 may be firmly coupled to the interior material 13, and the vibration transmitted through the coupling member 400 may be transmitted to the interior material 13 without loss.

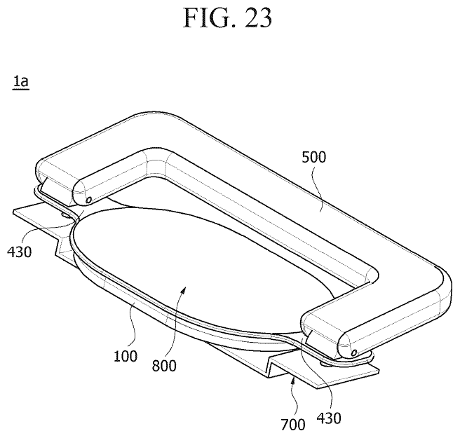

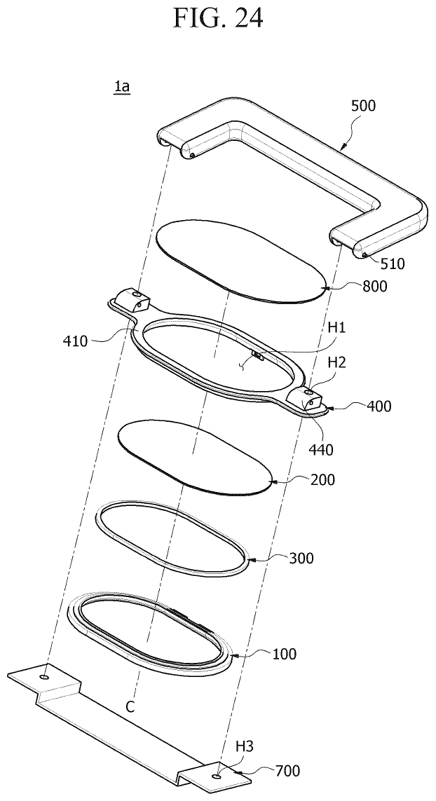

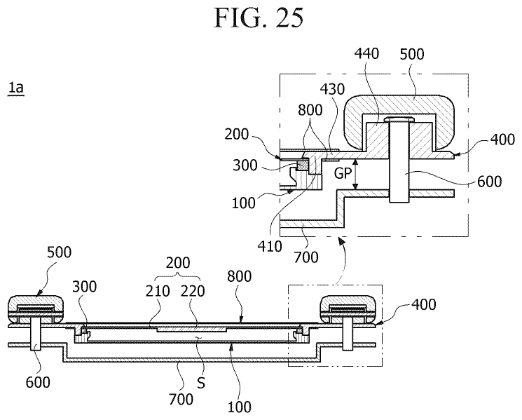

FIG. 23 is a perspective view illustrating a sound apparatus according to another implementation of the present specification. FIG. 24 is an exploded perspective view illustrating a sound apparatus according to another implementation of the present specification. FIG. 25 is a cross-sectional view illustrating a sound apparatus according to another implementation of the present specification. The sound apparatus illustrated in FIGS. 5 to 7 may represent a sound apparatus according to a first implementation of the present specification, and the sound apparatus illustrated in FIGS. 23 to 25 may represent a sound apparatus according to a second implementation of the present specification.

Referring to FIGS. 5 to 7 and FIGS. 23 to 25, comparing the sound apparatus 1 according to the first implementation and the sound apparatus 1a according to the second implementation, the sound apparatus 1a according to the second implementation may further include a cover 800 covering the first hole H1 of the coupling member 400.

In explaining the sound apparatus 1a according to the second implementation with reference to FIGS. 23 to 25, the same reference numerals are given to substantially identical components of the sound apparatus 1 according to the first implementation and the sound apparatus 1a according to the second implementation, so a detailed explanation thereof will be omitted.

The sound apparatus 1a according to the second implementation may include an enclosure 100, a sound generation module 200, a supporting member 300, a coupling member 400, and a cover 800. The sound apparatus 1a may include a handle 500 rotatably located on the coupling member 400. The sound apparatus 1a may further include a fastening member 600 and a bracket 700 for coupling with a headliner provided as the interior material 13. For example, the bracket 700 is located to be spaced apart from the coupling member 400 to have a predetermined gap GP, so the interior material 13 may be located in the gap GP (see FIG. 4). Accordingly, the fastening member 600 penetrating the second hole H2 of the coupling member 400 may couple to the third hole H3 of the bracket 700 after penetrating the interior material 13 (see FIGS. 4, 24, and 25).

Referring to FIGS. 23 to 25, the cover 800 may be located on the coupling member 400 to prevent the sound generation module 200 from being exposed to the outside. For example, the cover 800 may be located on the front surface (or upper surface) of the coupling member 400 to cover the first hole H1 of the coupling member 400. For example, the cover 800 may be located to cover the body part 410 of the coupling member 400, but is not necessarily limited thereto. For example, the cover 800 may also be located to cover the body part 410 of the coupling member 400 and a part of the extension part 430.

The end of the cover 800 may be located to cover up to the back surface of the body part 410. Accordingly, the end of the cover 800 may be located between the body part 410 and the interior material 13. When coupling the sound apparatus 1 and the interior material 13 through the fastening member 600, the end of the cover 800 may be adhered to the interior material 13 by the load applied to the body part 410. Accordingly, even if a certain pressure or load is applied to the cover 800, detachment of the cover 800 from the sound generation module 200 may be prevented. To prevent detachment of the cover 800, the cover 800 may be coupled to the coupling member 400 through an adhesive member.

The material of the cover 800 may be formed of the same material as the internal surface of the interior material 13, but the implementations of the present specification are not limited thereto. For example, the cover 800 may include a fiber material. For example, the cover 800 may include at least one of plastic composite fiber, carbon fiber (or aramid fiber), and natural fiber, and the implementations of the present specification are not limited thereto. For example, the cover 800 may be a woven sheet, a knit sheet, or a non-woven fabric, etc., and the implementations of the present specification are not limited thereto. For example, the cover 800 may be cone paper for speakers. For example, cone paper may be pulp or foamed plastic, etc., but the implementations of the present specification are not limited thereto. For example, the cover 800 may be a leather material. The cover 800 of leather material may include natural leather or artificial leather, and the implementations of the present specification are not limited thereto.

Therefore, since the material of the cover 800 is composed of the same material as the internal surface of the interior material 13, the cover 800 may minimize or reduce aesthetic heterogeneity by blending with the surface of the interior material 13. Also, there is an advantage that the position of the sound apparatus 1a is not exposed. For example, one surface of the cover 800 may form the same plane as one surface of the headliner provided as the interior material 13, but the implementations of the present specification are not limited thereto. The internal surface of the interior material 13 may be a surface exposed to the indoor space IS of the vehicle 10.

The first hole H1 of the coupling member 400 may serve as a sound emission part, a sound emission hole, a sound output part, a sound output hole, a sound output hole. Since the cover 800 is located to cover the first hole H1, the sound SO generated from the sound generation module 200 may be adjusted by the cover 800. For example, the sound SO generated from the sound generation module 200 may be adjusted according to the material of the cover 800.

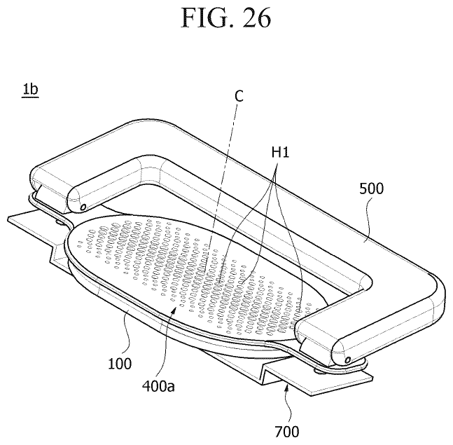

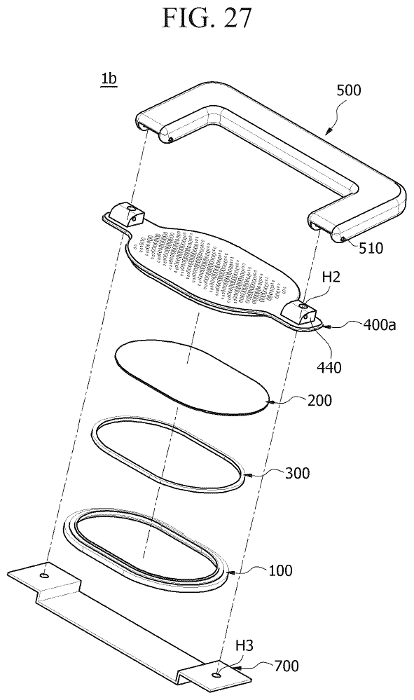

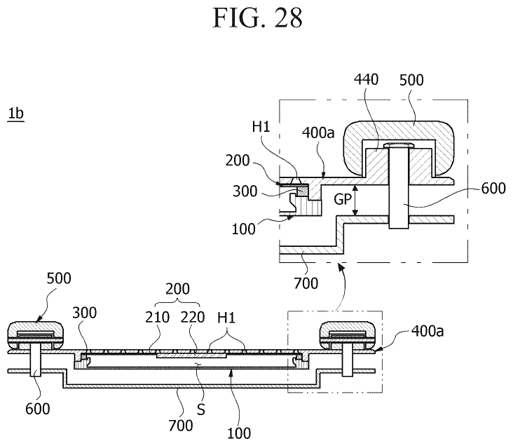

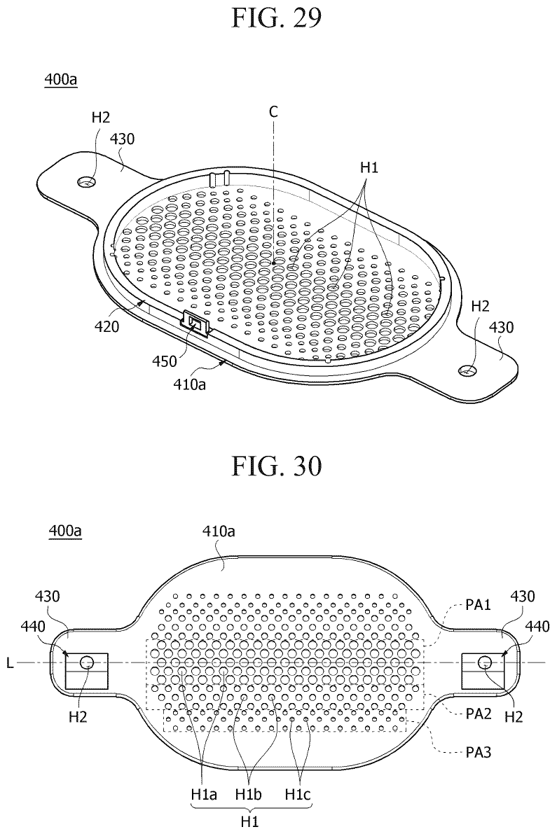

FIG. 26 is a perspective view illustrating a sound apparatus according to another implementation of the present specification. FIG. 27 is an exploded perspective view illustrating a sound apparatus according to another implementation of the present specification. FIG. 28 is a cross-sectional view illustrating a sound apparatus according to another implementation of the present specification. FIG. 29 is a rear perspective view illustrating a coupling member of a sound apparatus according to another implementation of the present specification. FIG. 30 is a plan view illustrating a coupling member of a sound apparatus according to another implementation of the present specification. The sound apparatus illustrated in FIGS. 26 to 28 may represent a sound apparatus according to a third implementation of the present specification.

Referring to FIGS. 5 to 7 and FIGS. 26 to 30, comparing the sound apparatus 1 according to the first implementation and the sound apparatus 1b according to the third implementation, the sound apparatus 1b according to the third implementation may include a coupling member 400a different from the coupling member 400 of the sound apparatus 1 according to the first implementation. For example, the coupling member 400a may include a structure where the sound generation module 200 is not exposed and a plurality of first holes H1 configured in the structure. The plurality of first holes H1 may be a sound emission part, a sound emission hole, a sound output part, a sound output hole, a sound output hole, or a vent hole, and the implementations of the present specification are not limited thereto.

In explaining the sound apparatus 1b according to the third implementation with reference to FIGS. 26 to 30, the same reference numerals are given to substantially identical components of the sound apparatus 1 according to the first implementation and the sound apparatus 1b according to the third implementation, so a detailed explanation thereof will be omitted.

The sound apparatus 1b according to the third implementation may include an enclosure 100, a sound generation module 200, a supporting member 300, and a coupling member 400a. The sound apparatus 1b may include a handle 500 rotatably located on the coupling member 400a. The sound apparatus 1b may further include a fastening member 600 and a bracket 700 for coupling with a headliner provided as the interior material 13. For example, the bracket 700 is located to be spaced apart from the coupling member 400 to have a predetermined gap GP, so the interior material 13 may be located in the gap GP (see FIG. 4). Accordingly, the fastening member 600 penetrating the second hole H2 of the coupling member 400 may couple to the third hole H3 of the bracket 700 after penetrating the interior material 13 (see FIGS. 4, 27, and 28).

Referring to FIGS. 26 to 30, the coupling member 400a may be located on the sound generation module 200 to prevent the sound generation module 200 from being exposed to the outside. For example, the coupling member 400a may be located on the front surface (or upper surface) of the sound generation module 200.

Referring to FIGS. 29 and 30, the coupling member 400a may include a body part 410a including a plurality of first holes H1 and a sidewall part 420 protruding in the Z-axis direction from the body part 410a. Also, the coupling member 400a may further include an extension part 430 extending from the body part 410a. The coupling member 400a may further include a protrusion part 440 protruding from the extension part 430. The coupling member 400a may further include a hook part 450 coupling with the protrusion 130 of the enclosure 100. The body part 410a, the sidewall part 420, the extension part 430, the protrusion part 440, and the hook part 450 may be integrally formed, but the implementations of the present specification are not limited thereto.

The body part 410a may be formed in a plate shape with a plurality of first holes H1 formed therein. Accordingly, the body part 410a may be formed in a plate shape that may cover the sound generation module 200 so that the sound generation module 200 is not exposed to the outside, but is not necessarily limited thereto. The plurality of first holes H1 may overlap with the vibration member 210.

The vibration of the vibration member 210 may vary according to the individual application or combination of the size, shape, opening rate, and placement position, etc. of the plurality of first holes H1. Accordingly, the sound characteristics and/or sound pressure characteristics generated from the vibration member 210 may be adjusted. For example, the sound characteristics and/or sound pressure characteristics generated according to the vibration of the vibration member 210 may be adjusted by adjusting the combination of the plurality of first holes H1 of different sizes and the placement position of the plurality of first holes H1. For example, the plurality of first holes H1 may include a plurality of first sub-holes H1a, a plurality of second sub-holes H1b, and a plurality of third sub-holes H1c of different sizes. For example, each of the first sub-holes H1a, the second sub-holes H1b, and the third sub-holes H1c may be formed in shapes with different sizes of horizontal cross-sections, but are not necessarily limited thereto. For example, the first sub-holes H1a, the second sub-holes H1b, and the third sub-holes H1c may be formed in the same shape with different sizes, but are not necessarily limited thereto. For example, the first sub-holes H1a, the second sub-holes H1b, and the third sub-holes H1c may be formed in at least one shape or a combination thereof among circular, oval, triangular, rectangular, and polygonal horizontal cross-sections. As shown in FIGS. 29 and 30, the horizontal cross-sections of the first sub-holes H1a, the second sub-holes Hlb, and the third sub-holes H1c may be formed in circular shapes with different diameters. For example, the diameter of the first sub-hole H1a may be larger than the diameter of the second sub-hole H1b, and the diameter of the second sub-hole Hlb may be larger than the diameter of the third sub-hole H1c.

Accordingly, the sound characteristics and/or sound pressure characteristics generated according to the vibration of the vibration member 210 may be adjusted. For example, the sound characteristics and/or sound pressure characteristics generated according to the vibration of the vibration member 210 may be adjusted according to the placement position of the first sub-holes H1a, the second sub-holes H1b, and the third sub-holes H1c with different diameters.

Referring to FIG. 30, the body part 410a may include a first region PA1 where the first sub-holes H1a are located, a second region PA2 where the second sub-holes H1b are located, and a third region PA3 where the third sub-holes H1c are located.

Considering the position of the vibration device 220, the first region PA1 may be located toward the center of the body part 410. Also, the second region PA2 may be located more outward than the first region PA1. The third region PA3 may be located more outward than the second region PA2. Accordingly, since the first sub-holes H1a with relatively large diameters are located in the first region PA1, the sound SO may be concentrated and output to the center of the vibration member 210.

The first region PA1, the second region PA2, and the third region PA3 may be located symmetrically with respect to an imaginary line L. Also, the first region PA1 may be located along the imaginary line L. The second region PA2 and the third region PA3 may be located parallel to the imaginary line L like the first region PA1, but the implementations of the present specification are not limited thereto. Here, the imaginary line L may be an imaginary line connecting the second holes H2 formed in the extension part 430.

Like the body part 410 of the coupling member 400 according to the first implementation, the body part 410a may include a central region A1 overlapping with the sidewall part, and an inner region A2 located on the inner side of the central region A1. Also, the body part 410a may further include an outer region A3 located on the outer side of the central region A1. The inner region A2 may be formed in a plate shape occupying all of the inner side of the central region A1. Also, the plurality of first holes H1 may be located in the inner region A2.

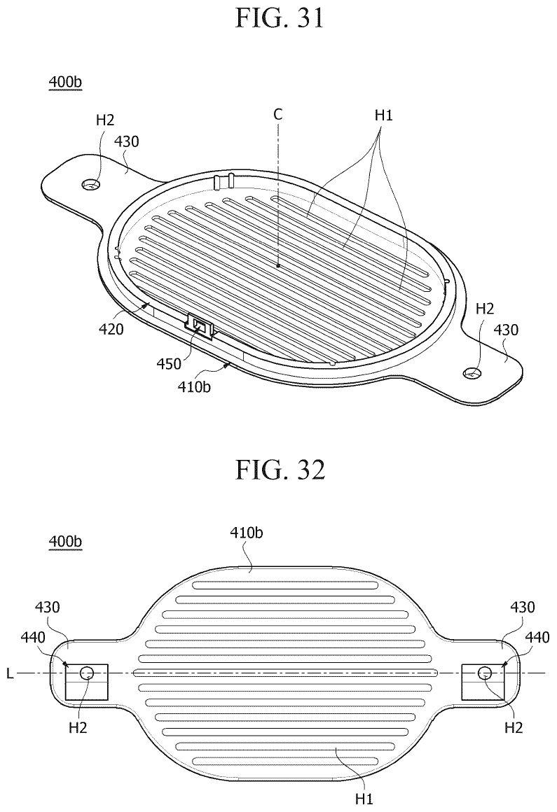

FIG. 31 is a rear perspective view illustrating another implementation of a coupling member located in a sound apparatus according to another implementation of the present specification. FIG. 32 is a plan view illustrating another implementation of a coupling member located in a sound apparatus according to another implementation of the present specification.

The coupling member 400b shown in FIGS. 31 and 32 may replace the coupling member 400a of the sound apparatus 1b according to the third implementation. Unlike the coupling member 400a of the sound apparatus 1b according to the third implementation, it may include a plurality of first holes H1 in a rectangular shape.

In explaining the coupling member 400b with reference to FIGS. 31 and 32, the same reference numerals are given to substantially identical components of the coupling member 400a of the sound apparatus 1b according to the third implementation, so a detailed explanation thereof will be omitted.

Referring to FIGS. 31 and 32, the coupling member 400b may include a body part 410b including a plurality of first holes H1 in a rectangular shape and a sidewall part 420 protruding in the Z-axis direction from the body part 410b. Also, the coupling member 400b may further include an extension part 430 extending from the body part 410b. The coupling member 400b may further include a protrusion part 440 protruding from the extension part 430. The coupling member 400b may further include a hook part 450 coupling with the protrusion 130 of the enclosure 100. The body part 410b, the sidewall part 420, the extension part 430, the protrusion part 440, and the hook part 450 may be integrally formed, but the implementations of the present specification are not limited thereto.

The body part 410b may be formed in a plate shape with a plurality of first holes H1 in a rectangular shape formed therein. For example, the plurality of first holes H1 located in the body part 410b may be rectangular with different lengths in width and height.

The vibration of the vibration member 210 may vary according to the individual application or combination of the size, shape, opening rate, and placement position, etc. of the first holes H1 formed in a rectangular shape. Accordingly, the sound characteristics and/or sound pressure characteristics generated from the vibration member 210 may be adjusted. For example, the sound characteristics and/or sound pressure characteristics generated according to the vibration of the vibration member 210 may be adjusted by adjusting the combination of the first holes H1 in rectangular shapes of different sizes and the placement position of the first holes H1 in rectangular shapes. For example, among the first holes H1 in rectangular shapes, the size of the rectangular first hole H1 located on the imaginary line L may be the largest, but is not necessarily limited thereto. Here, the imaginary line L may be an imaginary line connecting the second holes H2 formed in the extension part 430. For example, the first holes H1 in rectangular shapes may be located parallel to the imaginary line L, and the size may become smaller as they get farther from the imaginary line L, but are not necessarily limited thereto. For example, the first holes H1 in rectangular shapes may also be located perpendicular to the imaginary line L. Accordingly, the sound characteristics and/or sound pressure characteristics generated according to the vibration of the vibration member 210 may be adjusted.

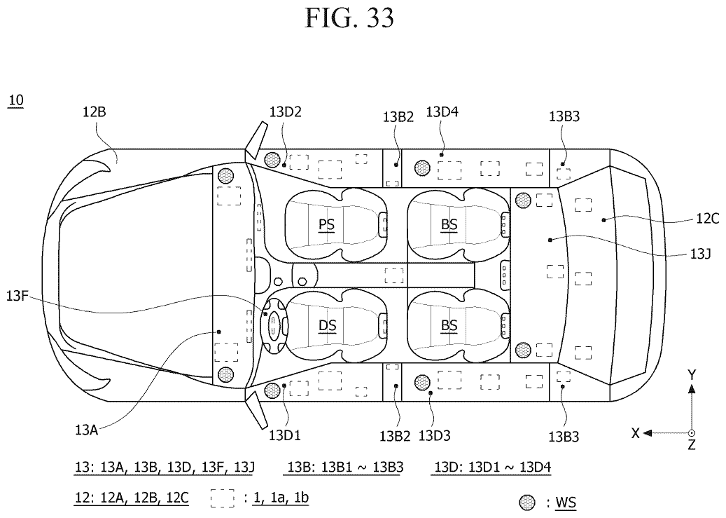

FIG. 33 is a diagram illustrating a transportation apparatus according to an implementation of the present specification. The reference symbol DS in FIG. 33 may indicate a driver's seat, the reference symbol PS may indicate a passenger seat, and the reference symbol BS may indicate a rear seat. The reference symbol WS in FIG. 33 may indicate a woofer speaker. The dotted boxes in FIG. 33 may indicate the placement position of the sound apparatuses 1, 1a, and 1c.

Referring to FIG. 33, the transportation apparatus 10 according to an implementation of the present specification may include an interior material 13 and one or more sound apparatuses 1, 1a, and 1c.

According to the present specification, one or more sound apparatuses 1, 1a, and 1c may be located in 4 directions based on the listener, but the implementations of the present specification are not limited thereto. Thereby, multi-channel sound may be configured. For example, it may be configured in a structure where one or more sound apparatuses 1, 1a, and 1c surround the listener, but the implementations of the present specification are not limited thereto.

According to an implementation of the present specification, the interior material 13 of the vehicle 10 may include at least one of a dash board, a pillar interior material (or pillar trim), a floor interior material (or floor carpet), a roof interior material (or headliner), a door interior material (or door trim), a handle interior material (or steering cover), a seat interior material, a rear package interior material (or rear seat shelf), an overhead console (or interior lighting interior material), a rear view mirror, a glove box, and a sun visor. One or more sound apparatuses 1, 1a, and 1c may vibrate at least one of a dash board, a pillar interior material (or pillar trim), a floor interior material (or floor carpet), a roof interior material (or headliner), a door interior material (or door trim), a handle interior material (or steering cover), a seat interior material, a rear package interior material (or rear seat shelf), an overhead console (or interior lighting interior material), a rear view mirror, a glove box, and a sun visor. Some components of one or more sound apparatuses 1, 1a, and 1c may be omitted depending on the placement position in the vehicle 10. For example, the protrusion part 440, the handle 500, and the shaft 510 of the sound apparatuses 1, 1a, and 1c may be omitted depending on the placement position of the sound apparatuses 1, 1a, and 1c.

One or more sound apparatuses 1, 1a, and 1c may be configured in an area between the interior material 13 and the main structure 11 of the vehicle 10 or an area between the interior material 13 and the exterior material 12 of the vehicle 10 or on the exterior material 12 or the interior material 13. For example, one or more sound apparatuses 1, 1a, and 1c or sound apparatus 30 may be located in an area between the interior material 13 and the main structure 11 of the vehicle 10 or an area between the interior material 13 and the exterior material 12 of the vehicle 10, and may output sound by indirectly vibrating at least one of the area between the interior material 13 and the main structure 11 of the vehicle 10 or the area between the interior material 13 and the exterior material 12 of the vehicle 10 or the exterior material 12 or the interior material 13.

The transportation apparatus 10 according to an implementation of the present specification may include a sound apparatus 1, 1a, and 1c configured to output sound from between the main structure 11 and the exterior material 12, between the main structure 11 and the interior material 13 of the vehicle 10, the exterior material 12, and the interior material 13, etc. For example, the sound apparatus 1, 1a, and 1c may be located in at least one of between the main structure 11 and the exterior material 12 of the transportation apparatus 10, between the main structure 11 and the interior material 13 of the vehicle 10, the exterior material 12, the interior material 13, or between the exterior material 12 and the interior material 13 of the vehicle 10 to output sound. For example, one or more sound apparatuses 1, 1a, and 1c located on the interior material 13 of the vehicle 10 may output sound. For example, the interior material 13 of the vehicle 10 may be exposed to the indoor space IS.

The sound apparatus 1, 1a, 1c may be located on at least one of a dash board 13A, a pillar interior material 13B, a door interior material 13D, a handle interior material 13F, and a rear package interior material 13J. The protrusion part 440, the handle 500, and the shaft 510 of the sound apparatuses 1, 1a, and 1c may be omitted depending on the placement position of the sound apparatuses 1, 1a, and 1c.

The sound apparatus and the transportation apparatus comprising the same according to one or more implementations of the present specification may be described as follows.

The sound apparatus according to one or more implementations of the present specification may include an enclosure, a sound generation module including a vibration member and a vibration device connected to the vibration member, a supporting member located on the enclosure, a coupling member contacting an edge of the vibration member and coupled to the enclosure, and a fixing member coupled to the coupling member.

According to one or more implementations of the present specification, the enclosure may include an enclosure body and an enclosure sidewall protruding from the enclosure body. The enclosure sidewall may include at least one step.

According to one or more implementations of the present specification, the enclosure sidewall may include a first portion and a second portion. A height of the first portion with respect to the enclosure body may be smaller than a height of the second portion.

According to one or more implementations of the present specification, the coupling member may include a body part having a hole and a sidewall part protruding from the body part toward the enclosure. The sidewall part may contact the enclosure sidewall.

According to one or more implementations of the present specification, an inner region of the body part located on an inner side of the sidewall part may contact the supporting member.

According to one or more implementations of the present specification, the supporting member may include foam rubber.

According to one or more implementations of the present specification, the enclosure and the coupling member may be hook-coupled.

According to one or more implementations of the present specification, the coupling member may include a body part having a hole, a sidewall part protruding from the body part toward the enclosure, an extension part extending from the body part, and a protrusion part protruding from the extension part. A shaft to which the fixing member is rotatably coupled may be coupled to the protrusion part.

According to an implementation of the present specification, the coupling member may include a body part having a plurality of first holes and overlapping with the vibration device, and a sidewall part protruding from the body part toward the enclosure. The plurality of first holes may include first sub-holes, second sub-holes, and third sub-holes. The size of the horizontal cross-section of each of the first sub-hole, the second sub-hole, and the third sub-hole may be different.

According to one or more implementations of the present specification, the body part may include a first region where the first sub-holes are located, a second region where the second sub-holes are located, and a third region where the third sub-holes are located. The first region may be located at the center of the body part. The size of the horizontal cross-section of the first sub-hole may be larger than the size of the horizontal cross-section of the second sub-hole.

According to one or more implementations of the present specification, it may further include two extension parts extending from the body part. Each of the two extension parts may include a second hole. The first region may be located along an imaginary line connecting the second holes.

According to one or more implementations of the present specification, the sound apparatus may further include a cover covering the hole of the coupling member.

According to one or more implementations of the present specification, the vibration device may include one or more vibration generators. The one or more vibration generators may include a vibration part including a piezoelectric material, a first electrode part on a first surface of the vibration part, and a second electrode part on a second surface different from the first surface of the vibration part.

The transportation apparatus according to one or more implementations of the present specification may include an interior material exposed to an indoor space, and at least one sound apparatus located on the interior material and outputting sound to the indoor space. The sound apparatus may include an enclosure, a sound generation module including a vibration member and a vibration device connected to the vibration member, a supporting member located on the enclosure, a coupling member contacting an edge of the vibration member and coupled to the enclosure, and a fixing member coupled to the coupling member.

According to one or more implementations of the present specification, the interior material may include one or more materials among metal, wood, rubber, plastic, carbon, glass, fiber, cloth, paper, mirror, and leather. The transportation apparatus may further include a cover covering the hole of the coupling member. The material of the cover and the material of the interior material may be identical.

According to one or more implementations of the present specification, the interior material may be configured as a headliner of a vehicle.

According to one or more implementations of the present specification, the coupling member may include a body part having a hole, a sidewall part protruding from the body part toward the enclosure, an extension part extending from the body part and located on a front surface of the headliner, and a protrusion part protruding from the extension part. The fastening member penetrating the extension part and the headliner may be coupled to the bracket located on a back surface opposite to the front surface of the headliner.

According to one or more implementations of the present specification, the fixing member may be exposed to an interior of a vehicle.

According to one or more implementations of the present specification, the coupling member may include a body part and a sidewall part protruding from the body part toward the enclosure. An inner region of the body part located on an inner side of the sidewall part may contact the supporting member.

According to one or more implementations of the present specification, an outer region of the body part located on an outer side of the sidewall part may overlap with the interior material.

The objects to be achieved by the present disclosure, the means for achieving the objects, and effects of the present disclosure described above do not specify essential features of the claims, and thus, the scope of the claims is not limited to the disclosure of the present disclosure.

Although the implementations of the present disclosure have been described in more detail with reference to the accompanying drawings, the present disclosure is not limited thereto and may be embodied in many different forms without departing from the technical concept of the present disclosure. Therefore, the implementations disclosed in the present disclosure are provided for illustrative purposes only and are not intended to limit the technical concept of the present disclosure. The scope of the technical concept of the present disclosure is not limited thereto. Therefore, it should be understood that the above-described implementations are illustrative in all aspects and do not limit the present disclosure.

What is claimed is:

1. A sound apparatus, comprising:
an enclosure;
a sound generation module including a vibration member and a vibration device configured to apply vibrations to the vibration member;
a supporting member located on the enclosure and configured to support the sound generation module;
a coupling member contacting an edge of the vibration member and coupled to the enclosure; and
a fixing member coupled to the coupling member.

2. The sound apparatus according to claim 1, wherein the enclosure includes an enclosure body and an enclosure sidewall protruding from the enclosure body, and
wherein the enclosure sidewall includes at least one step.

3. The sound apparatus according to claim 2, wherein the enclosure sidewall includes a first portion and a second portion that protrude from the enclosure body, and
wherein a height of the first portion relative to the enclosure body is smaller than a height of the second portion.

4. The sound apparatus according to claim 2, wherein the coupling member includes a body part having a hole and a sidewall part protruding from the body part toward the enclosure, and
wherein the sidewall part contacts the enclosure sidewall.

5. The sound apparatus according to claim 4, wherein an inner region of the body part protrudes from an inner side of the sidewall part and overlaps with the edge of the vibration member.

6. The sound apparatus according to claim 1, wherein the supporting member includes foam rubber.

7. The sound apparatus according to claim 1, wherein the enclosure and the coupling member are hook-coupled.

8. The sound apparatus according to claim 1, wherein the coupling member includes a body part having a hole, a sidewall part protruding from the body part toward the enclosure, an extension part extending from the body part, and a protrusion part protruding from the extension part, and
wherein a shaft, to which the fixing member is rotatably coupled, is coupled to the protrusion part.

9. The sound apparatus according to claim 1, wherein the coupling member overlaps with the vibration device and includes a body part having a plurality of first holes, and a sidewall part protruding from the body part toward the enclosure,
wherein the plurality of first holes include first sub-holes, second sub-holes, and third sub-holes, and
wherein sizes of horizontal cross-sections of each of the first sub-hole, the second sub-hole, and the third sub-hole are different.

10. The sound apparatus according to claim 9, wherein the body part includes a first region where the first sub-holes are located, a second region where the second sub-holes are located, and a third region where the third sub-holes are located,
wherein the first region is located at a center of the body part, and
wherein a size of a horizontal cross-section of the first sub-hole is larger than a size of a horizontal cross-section of the second sub-hole.

11. The sound apparatus according to claim 10, further comprising:
two extension parts extending from the body part,
wherein each of the two extension parts includes a second hole, and
wherein the first region is located along an imaginary line connecting the second holes.

12. The sound apparatus according to claim 1, wherein the coupling member further includes a hole, and
the sound apparatus further comprises a cover covering the hole of the coupling member.

13. The sound apparatus according to claim 1, wherein the vibration device includes one or more vibration generators,
wherein the one or more vibration generators include:
a vibration part including a piezoelectric material;
a first electrode part on a first surface of the vibration part; and
a second electrode part on a second surface different from the first surface of the vibration part.

14. A transportation apparatus comprising:
an interior surface exposed to an indoor space; and
at least one sound apparatus located on the interior surface and configured to output sound to the indoor space,
wherein the at least one sound apparatus includes,
an enclosure;
a sound generation module including a vibration member and a vibration device configured to apply vibrations to the vibration member;
a supporting member located on the enclosure and configured to support the sound generation module;
a coupling member contacting an edge of the vibration member and coupled to the enclosure; and
a fixing member coupled to the coupling member.

15. The transportation apparatus according to claim 14, wherein the interior surface includes one or more materials among metal, wood, rubber, plastic, carbon, glass, fiber, cloth, paper, mirror, and leather,
wherein the coupling member further includes a hole,
wherein the transportation apparatus further comprises a cover covering the hole of the coupling member, and
wherein a material of the cover and a material of the interior surface are identical.

16. The transportation apparatus according to claim 14, wherein the interior surface is configured as a headliner of a vehicle,
wherein the coupling member includes a body part and an extension part extending from the body part and located on a front surface of the headliner,
wherein the transportation apparatus further comprises:
a fastening member penetrating the extension part and the headliner; and
a bracket located on a back surface different from the front surface of the headliner, and
wherein the fastening member is coupled to the bracket.

17. The transportation apparatus according to claim 14, wherein the fixing member is exposed to an interior of a vehicle.

18. The transportation apparatus according to claim 14, wherein the coupling member includes a body part and a sidewall part protruding from the body part toward the enclosure, and
wherein an inner region of the body part protrudes from an inner side of the sidewall part and overlaps with the edge of the vibration member.

19. The transportation apparatus according to claim 18, wherein an outer region of the body part protrudes from an outer side of the sidewall part and overlaps with the interior surface.

20. A sound apparatus configured in an interior of a transportation apparatus, the sound apparatus comprising:
a sound generation module including a vibration member and a vibration device connected to and configured to apply vibrations to the vibration member;
an enclosure that accommodates the sound generation module, wherein the enclosure is coupled to an edge of the vibration member of the sound generation module;
a coupling member coupled to the enclosure and to the edge of the vibration member to secure the sound generation module, wherein the coupling member is further coupled to an interior surface of the transportation apparatus; and
a fixing member rotatably coupled to the coupling member.
